(19) United States
(12) Patent Application Publication
(10) Pub. No.: US 2020/0277139 A1
(43) Pub. Date: Sep. 3, 2020

(54) WAREHOUSE SYSTEM

(71) Applicant: HITACHI INDUSTRIAL PRODUCTS, LTD., Tokyo (JP)

(72) Inventors: Koichi NAKANO, Tokyo (JP); Akiharu IKEDA, Tokyo (JP); Tatsuhito SAGAWA, Tokyo (JP); Kouki ONO, Tokyo (JP)

(21) Appl. No.: 16/650,002

(22) PCT Filed: Feb. 18, 2019
(86) PCT No.: PCT/JP2019/005922

§ 371 Date: Mar. 24, 2020

(30) Foreign Application Priority Data
Mar. 27, 2018 (JP) 2018-060155

(51) Int. Cl. B65G 1/137; B25J 9/16

(52) U.S. Cl. CPC B65G 1/1373; B25J 9/1605; B25J 9/163

(57) ABSTRACT

An arm robot is configured to take an object out of a storage shelf and a transfer robot is configured to transfer the storage shelf together with the object to an operation range of the arm robot. A robot teaching database stores raw teaching data for the arm robot based on a storage shelf coordinates model value that is a three-dimensional coordinates model value of the storage shelf and a robot hand coordinates model value that is a three-dimensional coordinates model value of the robot hand. A robot data generation unit is configured to correct the raw teaching data based on a detection result of a sensor detecting a relative position relationship between the storage shelf and the robot hand, and generate robot teaching data to be supplied to the arm robot.

### TECHNICAL FIELD

The present invention relates to a warehouse system.

### BACKGROUND ART

Robots that perform a transfer operation of transferring cargoes from one location to another location are referred to as unmanned vehicles or AGVs (Automatic Guided Vehicles). The AGVs have been widely used in facilities such as warehouses, factories, and harbors. Most operations for physical distribution in facilities may be automated by combining the cargo delivery operation occurring between storage sites and the AGVs, that is, the cargo handling operation with cargo handling devices for automatically performing the cargo handling operation.

With the recent diversification of consumers' needs, warehouses that handle low-volume and high-variety objects, for example, objects for mail-order sales have increased. In terms of characteristics of objects to be managed, it takes much time and labor costs to search objects and load/unload cargoes. For this reason, it is further demanded that the operations for physical distribution in facilities are automated for the warehouse for mail-order sales as compared with conventional warehouses that handle a large amount of one item.

Patent literature 1 discloses a system that is suitable for transferring objects in warehouses for mail-order sales that handle various types of objects, and for transferring parts in factories that produce high-variety and low-volume parts. In the system, movable storage shelves are disposed in a space of the warehouse, and a transfer robot is coupled to the shelf that stores requested objects or parts. Then, the transfer robot transfers the storage shelf together with the objects to a work area where the objects are packed, products are assembled, or so on.

### CITATION LIST

### Patent Literature

Patent Literature 1: JP2009-539727A

### SUMMARY OF THE INVENTION

### Technical Problem

The transfer robot in Patent literature 1 enters into a space below an inventory holder (shelf) having a plurality of inventory trays that directly store respective inventory items, lifts the inventory holder, and transfers the inventory holder in this state. Patent literature 1 describes in detail the technique of correcting displacement of an actual destination from a theoretical destination of the inventory holder due to a positional mismatch between the moving transfer robot and the inventory. However, the literature fails to focus on efficient and individual management of various types of objects. Accordingly, it is required to provide another means of loading target objects into a correct movable shelf, and unloading target objects from a correct movable shelf.

The present invention is made in light of the above-mentioned circumstances, and its object is to provide a warehouse system capable of correctly managing the inventory state of individual objects.

### Solution to Problem

A warehouse system of the present invention for solving the above-described problems includes:

a storage shelf configured to store an object;

an arm robot including a mono-articulated or multi-articulated robot arm, a robot body supporting the robot arm, and a robot hand that is attached to the robot arm and grasps the object, the arm robot being configured to take the object out of the storage shelf;

a transfer robot configured to transfer the storage shelf together with the object to an operation range of the arm robot;

a robot teaching database configured to store raw teaching data that are teaching data for the arm robot based on a storage shelf coordinates model value that is a three-dimensional coordinates model value of the storage shelf and a robot hand coordinates model value that is a three-dimensional coordinates model value of the robot hand; and

a robot data generation unit configured to correct the raw teaching data based on a detection result of a sensor detecting a relative position relationship between the storage shelf and the robot hand, and to generate robot teaching data to be supplied to the arm robot.

In addition, a warehouse system of the present invention for solving the above-described problems includes:

a plurality of storage shelves each assigned to any of a plurality of zones divided on a floor surface and each configured to store a plurality of objects;

an arm robot including a mono-articulated or multi-articulated robot arm, a robot body supporting the robot arm, and a robot hand that is attached to the robot arm and grasps the object, the arm robot being configured to take the object out of the storage shelf;

transfer robots each assigned to any of the zones, each transfer robot being configured to transfer the storage shelf together with the objects from the assigned zone to an operation range of the arm robot; and

a controller configured to perform simulation of loading the object for each of the zones when the object to be unloaded is designated, and to determine the zone subjected to unloading processing of the object based on a result of the simulation.

In addition, a warehouse system of the present invention for solving the above-described problems includes:

a plurality of transfer lines each configured to transfer a transfer target; and

an analysis processor configured to, when a sensor detecting a state of one of the transfer lines determines that the one transfer line is crowded, instruct an operator to transfer the transfer target to another one of the transfer lines.

In addition, a warehouse system of the present invention for solving the above-described problems includes:

a dining table-shaped receiving base having an upper plate;

a transfer robot configured to enter below the receiving base and push the upper plate upwards, thereby supporting and moving the receiving base; and

a controller configured to horizontally rotate the transfer robot supporting the receiving base, provided that an inspection target placed on the upper plate is present in an inspectable range.

In addition, a warehouse system of the present invention for solving the above-described problems includes:

a plurality of storage shelves arranged in respective predetermined arrangement places on a floor surface, the storage shelves each being configured to store a plurality of unloadable objects;

a transfer robot configured to, when any of the plurality of objects is designated to be unloaded, transfer the storage shelf storing the designated object to an unloading gate provided at a predetermined position; and

a controller configured to predict frequencies with which the plurality of storage shelves are transferred to the unloading gate based on past unloading records of the plurality of objects, and when the frequency of a second storage shelf is higher than the frequency of a first storage shelf among the plurality of storage shelves and an arrangement place of the second storage shelf is further from the unloading gate than an arrangement place of the first storage shelf is, to change the arrangement place of the first storage shelf or the second storage shelf such that the arrangement place of the second storage shelf is closer to the unloading gate than the arrangement place of the first storage shelf is.

In addition, a warehouse system of the present invention for solving the above-described problems includes:

a bucket configured to store an object;

a plurality of storage shelves arranged in respective predetermined arrangement places on a floor surface, the storage shelves each being configured to store the plurality of unloadable objects in a state of being stored in the bucket;

a transfer robot configured to, when any of the plurality of objects is designated to be unloaded, transfer the storage shelf storing the designated object to an unloading gate provided at a predetermined position;

a stacker crane provided at the unloading gate, the stacker crane being configured to take the bucket storing the designated object out of the storage shelf; and

an arm robot configured to take the designated object out of the bucket taken by the stacker crane.

In addition, a warehouse system of the present invention for solving the above-described problems includes:

a storage shelf configured to store an object to be unloaded;

a sort shelf configured to sort the object for each destination;

an arm robot configured to take the object out of the storage shelf and store the taken object in a designated place in the sort shelf; and

a transfer device configured to move the arm robot or the sort shelf so as to reduce a distance between the arm robot and the designated place.

In addition, a warehouse system of the present invention for solving the above-described problems includes: a controller configured to perform such a control as to reduce a speed of the transfer robot as the transfer robot comes closer to an obstacle based on a detection result of a sensor detecting the transfer robot and the obstacle to the transfer robot.

### Advantageous Effect of Invention

According to the present invention, the inventory state of individual objects may be correctly managed.

### BRIEF DESCRIPTION OF DRAWINGS

FIG. 1 is a schematic configuration view showing a warehouse system in accordance with an embodiment of the present invention;

FIG. 2 is a plan view showing a warehouse;

FIG. 3 is a view showing the form of an object to be stored in a storage shelf;

FIG. 4 is an example of a perspective view showing a transfer robot;

FIG. 5 is a block diagram showing a central controller;

FIG. 6 is a block diagram showing a configuration of off-line teaching and robot operation track correction;

FIG. 7 is a block diagram showing detailed configuration of a first robot data generation unit and a second robot data generation unit;

FIG. 8 is a view showing a control configuration of the off-line teaching and the robot operation track correction;

FIG. 9 is a schematic view showing absolute coordinates obtained by a coordinate calculation unit;

FIG. 10 is a block diagram showing a configuration in which off-line teaching for an arm robot is performed in a collection and inspection area;

FIG. 11 is a block diagram showing another configuration in which off-line teaching for the arm robot is performed in the collection and inspection area;

FIG. 12 is a flow chart of simulation performed in each zone by a central controller;

FIG. 13 is an explanatory view showing a transfer robot operation sequence;

FIG. 14 is an explanatory view showing operations of off-line teaching for the arm robot;

FIG. 15 is a block diagram showing another configuration of off-line teaching and robot operation track correction;

FIG. 16 is a block diagram showing a detailed configuration of a second robot data generation unit in FIG. 15;

FIG. 17 is a flow chart of processing executed by the second robot data generation unit;

FIG. 18 is a block diagram showing an analysis processor in the present embodiment;

FIG. 19 is a schematic view showing operations of the analysis processor in the present embodiment;

FIG. 20 is a schematic view showing a method of inspecting objects loaded using the transfer robot in the warehouse system;

FIG. 21 is a block diagram showing an inspection system applied to an inspection operation;

FIG. 22 is a flow chart of inspection processing;

FIG. 23 is a plan view showing a zone;

FIG. 24 is a block diagram showing a storage shelf interchange system applied to interchange processing of storage shelves;

FIG. 25 is a flow chart of a shelf arrangement routine;

FIG. 26 is a schematic view showing a configuration in which a bucket is taken out of the storage shelf;

FIG. 27 is a schematic view showing another configuration in which the bucket is taken out of the storage shelf;

FIG. 28 is a flow chart of processing applied to the configuration shown in FIG. 27 by a central controller;

FIG. 29 is a schematic view showing a configuration in which the target object is taken out of the storage shelf and stored in a sort shelf at an unloading gate;

FIG. 30 is a flow chart of processing applied to the configuration shown in FIG. 29 by the central controller;

FIG. 31 is a schematic view showing a configuration in which the target object is taken out of the storage shelf and sorted to another storage shelf at the unloading gate;

FIG. 32 is a schematic view showing another configuration in which the target object is taken out of the storage shelf and stored in another storage shelf at the unloading gate;

FIG. 33 is a flow chart of processing applied to the configuration shown in FIGS. 31 and 32 by the central controller;

FIG. 34 is an explanatory view showing operations in the case where the transfer robot detects an obstacle;

FIG. 35 is a schematic view in the case where a plurality of transfer robots move along different paths; and

FIG. 36 is a flow chart showing processing performed to avoid a collision of the operator with the obstacle by the central controller.

### DESCRIPTION OF EMBODIMENTS

### [Overall Configuration of Warehouse System]

### <Schematic Configuration>

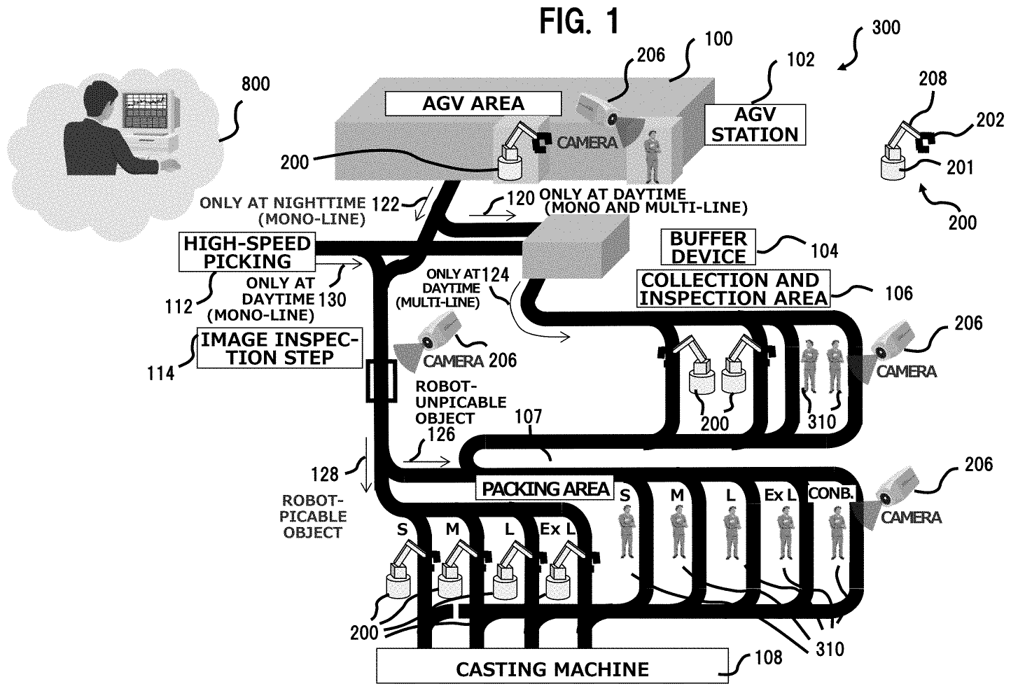

FIG. 1 is a schematic configuration view showing a warehouse system in accordance with an embodiment of the present invention.

A warehouse system 300 includes a central controller 800 (controller) that controls the overall system, a warehouse 100 that stores objects as inventory, a buffer device 104 that temporarily stores objects to be sent, a collection and inspection area 106 that collects and inspects the objects to be sent, a packing area 107 that packs the inspected objects, and a casting machine 108 that conveys the packed objects to delivery trucks and the like.

The warehouse 100 is an area where a below-mentioned transfer robot (AGV, Automatic Guided Vehicle) operates, and includes a storage shelf that stores objects, a transfer robot (not shown), an arm robot 200, and a sensor 206. Here, the sensor 206 has a camera that retrieves images of the entire warehouse including the transfer robot and the arm robot 200 as data.

As shown in a right end in FIG. 1, the arm robot 200 includes a robot body 201, a robot arm 208, and a robot hand 202. The robot arm 208 is a mono-articulated or multi-articulated robot arm, and the robot hand 202 is attached to one end of the robot arm. The robot hand 202 is multi-fingered and grasps various objects. The robot body 201 is installed at each part in the warehouse system 300, and holds the other end of the robot arm 208.

The operation of grasping and conveying various objects with the robot arm 208 and the robot hand 202 is referred to as “picking”.

Although details will be described later, in the present embodiment, the arm robot 200 executes learning through off-line teaching to achieve accurate and high-speed picking.

By switching an object processing line between daytime and nighttime, the process of transferring objects through the casting machine 108 may be made efficient.

For example, at daytime, objects unloaded from the warehouse 100 are temporarily stored in the buffer device 104 via a transfer line 120 such as a conveyor. Objects picked from other warehouses are also temporarily stored in the buffer device via a transfer line 130.

The central controller 800 determines whether or not the objects in the buffer device 104 are to be sent based on a detection result of the sensor 206 provided in the downstream collection and inspection area 106. When the determination result is “Yes”, the objects stored in the buffer device 104 are taken out of the buffer device 104 and transferred to a transfer line 124.

In the collection and inspection area 106, the sensor 206 detects and determines the type and state of the transferred objects. When it is determined that the objects need to be inspected by an operator 310, the objects are transferred to a line where the operator 310 is present. On the contrary, when it is determined that the objects do not need to be inspected by the operator 310, the objects are transferred to a line where only the arm robot 200 is present, and then, inspected. Since the lot of operators 310 are ensured at daytime, the sensor 206 determines hard-to-handle objects, and the objects are transferred to the line where the operator 310 is present at daytime, thereby efficiently inspecting the objects.

Easy-to-handle objects are inspected in the line where only the arm robot 200 is present, thereby reducing the number of the operators 310 to efficiently inspecting the objects as a whole.

Then, the objects are sent to the downstream packing area 107. Also, in the packing area 107, the sensor 206 determines the state of the transferred objects. According to the state, the objects are classified and transferred to a corresponding line, for example, a line for small-sized objects, a line for medium-sized objects, a line for large-sized objects, a line for extra large-sized objects, or a line for objects of various size and states. In each of the lines, the operator 310 packs the objects, and the packed objects are transferred to the casting machine 108 and waits for shipping.

Since a lot of operator 310 may be ensured at daytime, the sensor 206 may determine the hard-to-handle objects, and the objects may be transferred to the line where the operator 310 is present at daytime, thereby efficiently inspecting the objects. The easy-to-handle objects may be inspected in the line where only the arm robot 200 is present, thereby efficiently inspecting the objects as a whole.

Next, at nighttime, the objects unloaded from the warehouse 100 are transferred to an image inspection step 114 via a nighttime transfer line 122. The sensor 206 is used to measure the productivity of the arm robot 200 or the operator 310 both at daytime and nighttime. In the image inspection step 114, in place of the collection and inspection area 106, the sensor 206 determines whether or not the target objects are correctly transferred from the warehouse 100 one by one.

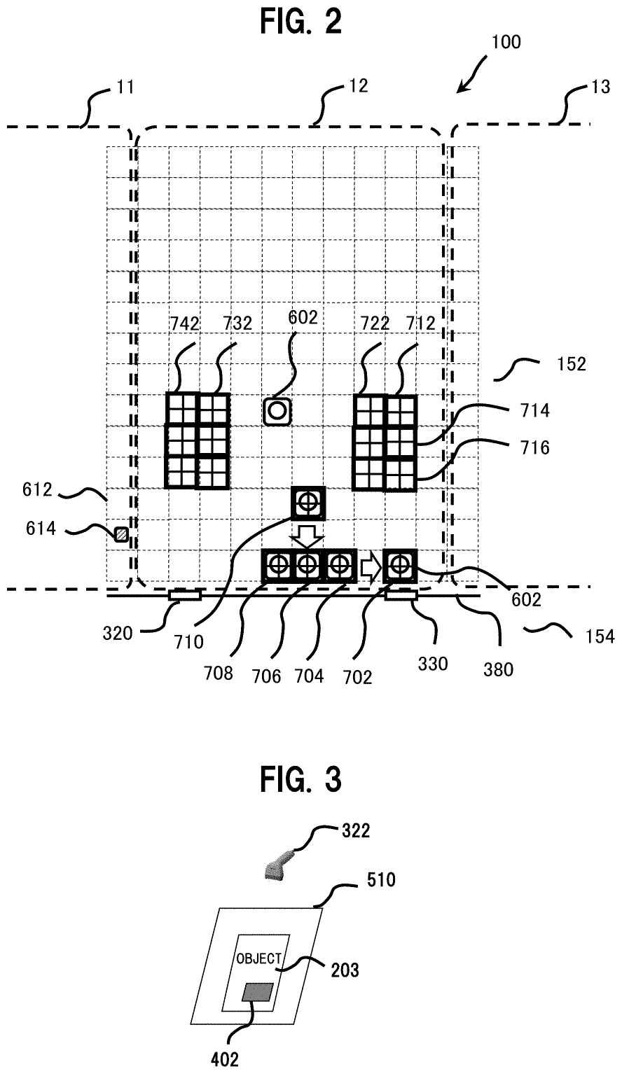

Thereby, the operator 310 may take the target objects from a storage shelf 702 in the warehouse 100 (see FIG. 2) substantially reliably using the transfer robot. This makes it possible to achieve omission and replacement of the operator's inspection operation with only inspection of the sensor 206. Based on a measurement result of the sensor 206, the central controller 800 determines whether or not the target objects can be picked by the arm robot 200, that is, whether or not the packing operation of the operator 310 is required.

When it is determined that the packing operation of the operator 310 is required, the objects are transferred to the line where the operator 310 is present in the packing area via a transfer line 126. On the contrary, when it is determined that the arm robot 200 can pack the objects, the objects are transferred to the line where the particular arm robot 200 is arranged according to the shape of the objects, such as small, medium, large, and extra-large. The objects packed by the operator 310 and the arm robot 200 are transferred to the casting machine 108, and waits for final shipping.

As described above, in the warehouse system 300 in the present embodiment, at daytime when man power of the operator is ensured, the hard-to-handle objects of complicated shape are unloaded from the warehouse, and the operator, with the operator's decision, casts the objects from the collection and inspection area via the packing area. On the contrary, at nighttime when manpower of the operator is less ensured, the easy-to-handle objects of simple shape are mainly transferred to the packing area 107 without passing through the collection and inspection area 106. Such configuration makes it possible for the warehouse system 300 to achieve efficient shipping of the objects on a 24-hour basis.

### <Summary of Warehouse>

FIG. 2 is a plan view showing the warehouse 100.

A floor surface 152 of the warehouse 100 is divided into a plurality of virtual grids 612. A bar code 614 indicating the absolute position of the grid 612 is adhered to each grid 612. However, FIG. 2 shows only one bar code 614.

In the warehouse system 300, the entire floor surface 152 of the warehouse is divided into a plurality of zones 11, 12, 13 . . . . A transfer robot 602 and the storage shelf 702 that move in the zone are assigned to each zone.

The warehouse 100 is provided with a wire netting wall 380. The wall 380 separates areas where the transfer robot 602 and the storage shelf 702 move (that is, the zones 11, 12, 13 . . . ) from a work area 154 where the operator 310 or the arm robot 200 (see FIG. 1) operates.

The wall 380 is provided with a loading gate 320 and an unloading gate 330. Here, the loading gate 320 is a gate for loading objects into the target storage shelf 702 and the like. The unloading gate 330 is a gate for unloading objects from the target storage shelf 702 and the like. A “shelf island” consisting of, for example, the storage shelves 702 are provided on the floor surface 152, and in this example, two “shelf islands” each consisting of 2 columns×3 rows of storage shelves. However, any shape and any number of “shelf islands” may be used. The transfer robots 602 may take a target storage shelf from the “shelf island” and move the target storage shelf.

At loading of the objects, the transfer robot 602 moves the target storage shelf to the front of the loading gate 320. When the operator 310 receives the target objects, the transfer robot 602 moves the storage shelf to a next target grid. Further, at unloading of the objects, the transfer robot 602 extracts a target storage shelf from, for example, the “shelf island”, and moves the target shelf to the front of the unloading gate 330. The operator 310 takes the target objects out of the storage shelf.

As represented by a storage shelf 712 in FIG. 2, a square containing a cross line indicates the shelf, and a square containing a circle indicates the transfer robot 602. As represented by the storage shelf 702 in front of the unloading gate 330, the storage shelf in which with a circle and a cross line overlap indicates the storage shelf supported by the transfer robot. Although details will be described later, the transfer robot 602 enters below the storage shelf and the upper side of the transfer robot 602 pushes the bottom of the shelf upwards to support the storage shelf. The storage shelf 702 shown in FIG. 2 is in this state.

The area of the floor surface 152 of the warehouse 100, in which the transfer robot 602 and the storage shelf 702 are disposed, may have any dimension.

### <Form of Object>

FIG. 3 is a view showing the form of the object to be stored in the storage shelf.

In the example shown in FIG. 3, one object 203 is stored in one object bag 510. An ID tag 402 using RFID is attached to the object 203.

Although one object is stored in one object bag in this example, a plurality of objects may be stored in one object bag, and an RFID may be attached to each object. An RFID reader 322 reads the ID tag 402 to read a unique ID of each object. In place of the ID tags using the RFID, bar codes and a bar code scanner may be used to manage objects. The RFID reader 322 may be a handy-type or a fixed-type.

### <Transfer Robot>

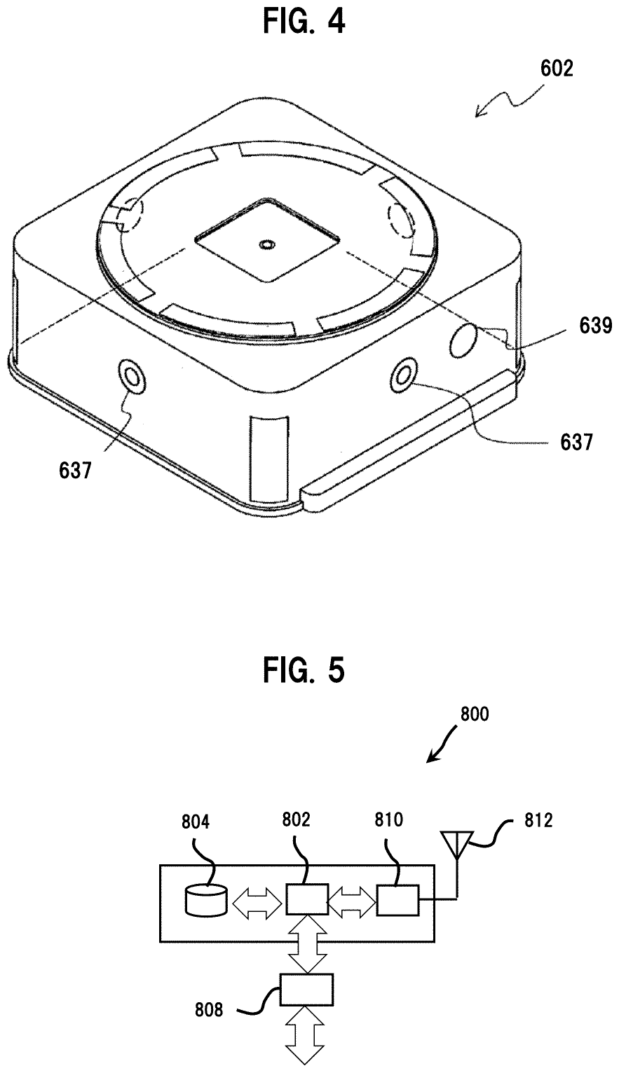

FIG. 4 is an example of a perspective view showing the transfer robot 602.

The transfer robot 602 is an unmanned automated travelling vehicle driven by the rotation of a wheel (not shown) on its bottom. A collision detection unit 637 of the transfer robot 602 detects a surrounding obstacle prior to collision with an optical signal (infrared laser or the like) sent being blocked by the obstacle. The transfer robot 602 includes a communication device (not shown). The communication device includes a wireless communication device for the communication with the central controller 800 (see FIG. 1) and an infrared communication unit 639 for the infrared communication with surrounding facilities such as a charge station.

As described above, the transfer robot 602 enters below the storage shelf, and the upper side of the transfer robot 602 pushes the bottom of the shelf upwards to support the storage shelf. Thereby, instead of that the operator walks to the vicinity of the shelf, the transfer robot 602 that transfers the shelf gets close to the surroundings of the operator 310, achieving efficient picking of the cargo on the shelf.

The transfer robot 602 includes a camera on its bottom (not shown), and the camera reads the bar code 614 (see FIG. 2), such that the transfer robot 602 recognizes the grid 612 on the floor surface 152, in which the transfer robot 602 lies. The transfer robot 602 informs the result to the central controller 800 via the wireless communication device (not shown).

The transfer robot 602 may include a LiDAR sensor that measures the distance to a surrounding obstacle by laser in place of the bar code 614 (see FIG. 2).

### <Central Controller 800>

FIG. 5 is a block diagram showing the central controller 800.

The central controller 800 includes a central processing unit 802, a database 804, an input/output unit 808, and a communication unit 810. The central processing unit 802 performs various operations. The database 804 stores data on the storage shelf 702, an object 404, and so on. The input/output unit 808 inputs/outputs information to/from external equipment. The communication unit 810 performs wireless communication according to a communication mode such as Wi-Fi via an antenna 812 to input/output information to/from the transfer robot 602 or the like.

### [Arm Robot Operational Track Correction by Off-Line Teaching]

### <Summary of Off-Line Teaching>

Operations of picking objects from the storage shelf 702 that moves together with the transfer robot 602 (see FIG. 2) using the arm robot 200 in the warehouse 100 (see FIG. 1) will be described in detail below. When the object is picked from the storage shelf using the arm robot 200, in order to process all operations in real time, arithmetic processing takes relatively long time.

Thus, it is suggested to set control parameters off-line in the time period when arm robot 200 is not operating. However, in this case, control parameters need to be set in advance using a teaching pendant, robot-specific off-line teaching software, or the like, for each type of the arm robot 200, each type of the storage shelf 702, each type of a container containing the objects, and each shape of the object, which results in enormous volume of work.

Accordingly, when the off-line teaching is merely introduced, static errors such as an installation error of the robot body 201 may be corrected, but dynamic errors that vary at different times, for example, a positional error of the storage shelf moved by the transfer robot may not be easily corrected.

The present embodiment solves these problems and achieves high-speed picking of objects.

In the present embodiment, the arm robot 200 is caused to learn a picking operation pattern off-line for each type of transfer robot, each type of storage shelf, each type of container containing objects, and each shape of object. At actual picking, the robot arm 208 is driven based on data in off-line, while the sensor 206 detects the position of the transfer robot, the position of the storage shelf moved to a picking station, and the actual position of the arm robot, and the positions are corrected in real time to perform operation track correction of the robot arm. In this manner, the objects are picked correctly and rapidly.

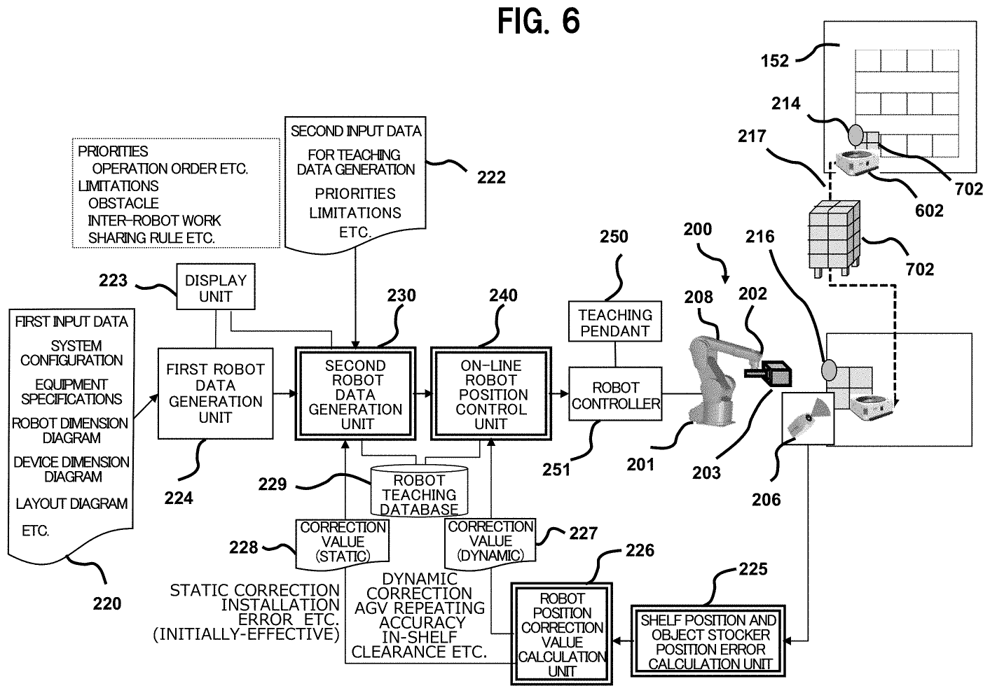

FIG. 6 is a block diagram showing a configuration of off-line teaching and robot operation track correction in the present embodiment.

As described above, the arm robot 200 includes the robot arm 208 and the robot hand 202, which are driven to move the object 203. On the floor surface 152, the transfer robot 602 moves the storage shelf 702. Before transfer, the transfer robot 602 mounts the storage shelf 702 and the like thereon at a shelf position 214 on the floor surface 152. The transfer robot 602 moves to a transferred shelf position 216 along a transfer path 217. Here, the shelf position 216 is a position adjacent to the work area 154, that is, a position adjacent to the loading gate 320 or the unloading gate 330 (see FIG. 2).

The shelf position and the object stocker position in the shelf, which vary due to behavior of the arm robot 200 and the transfer robot 602, are monitored by the sensor 206 of the image camera.

An off-line robot teaching data generation step and an off-line robot teaching data generation step will be described below.

In FIG. 6, first input data 220 are data on system configuration, equipment specifications, robot dimension diagram, device dimension diagram, and layout diagram. For off-line robot teaching, the first input data 220 is input to a first robot data generation unit 224. Thereby, the first robot data generation unit 224 generates raw teaching data (not shown) based on the first input data 220.

A second robot data generation unit 230 (robot data generation unit) is used for off-line robot teaching. The raw teaching data output from the first robot data generation unit 224 and second input data 222 are input to the second robot data generation unit 230. Here, the second input data 222 include priorities, operation order, limitations, information on obstacle, inter-robot work sharing rules, and so on.

On the contrary, information from the sensor 206 that images the arm robot 200 is input to a shelf position and object stocker position error calculation unit 225. Based on the input information, the shelf position and object stocker position error calculation unit 225 calculates a positional error of the moving shelf and a positional error of the object stocker (container that stores a plurality of objects). The calculated positional errors are input to a robot position correction value calculation unit 226.

The robot position correction value calculation unit 226 outputs a static correction value 228 indicating an initially-effective static correction installation error. The robot position correction value calculation unit 226 outputs a dynamic correction value 227 indicating dynamic correction AGV repeat accuracy in-shelf clearance.

The static correction value 228 is input to the second robot data generation unit 230, and the dynamic correction value 227 is input to an on-line robot position control unit 240. Data from a robot teaching database 229 are also input to the second robot data generation unit 230 and the on-line robot position control unit 240.

The second robot data generation unit 230 generates robot teaching data based on the raw teaching data, the second input data 222, and the static correction value 228 from the first robot data generation unit 224, and data from the robot teaching database 229. The generated robot teaching data are input to the on-line robot position control unit 240. A signal from the on-line robot position control unit 240 is input to a robot controller 252. The robot controller 252 controls the arm robot 200 according to the signal from the on-line robot position control unit 240 and a command input from a teaching pendant 250.

### <Detailed Configuration of Robot Teaching Data>

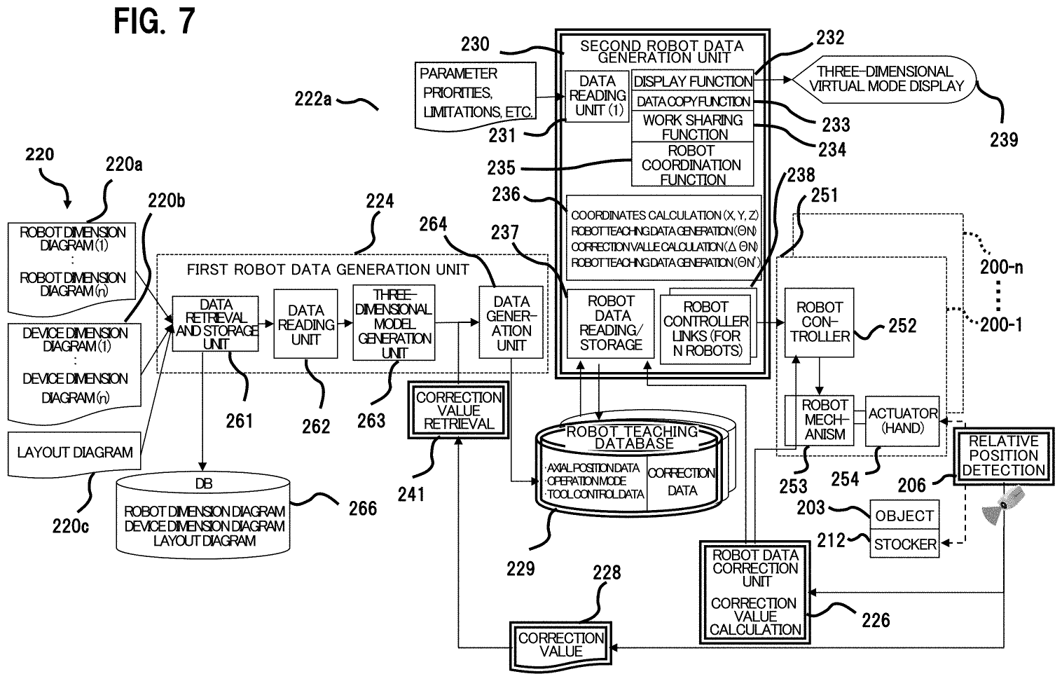

FIG. 7 is a block diagram showing a detailed configuration of the above-mentioned first robot data generation unit 224 and the second robot data generation unit 230.

The first input data 220 includes robot dimension data 220a, device dimension data 220b, and layout data 220c. In FIG. 7, the terms “data” in the robot dimension data 220a, the device dimension data 220b, and the layout data 220c is omitted. Here, the robot dimension data 220a identify dimensions of parts of n arm robots 200-1 to 200-n. The device dimension data 220b identify dimensions various devices included in the n arm robots 200-1 to 200-n. The layout data 220c identify layout of the warehouse 100 (see FIG. 2).

The first robot data generation unit 224 includes a data retrieval and storage unit 261, a data reading unit 262, a three-dimensional model generation unit 263, and a data generation unit 264 (robot data generation unit). The above-mentioned robot dimension data 220a, the device dimension data 220b, and the layout data 220c are supplied to the data retrieval and storage unit 261 in the first robot data generation unit 224.

A signal from the data retrieval and storage unit 261 is input to the data reading unit 262 as well as a database 266 that stores robot dimension diagram, device dimension diagram, and layout diagram. A signal from the data reading unit 262 is input to the three-dimensional model generation unit 263.

A signal from the three-dimensional model generation unit 263 is input to the data generation unit 264, and a signal from a correction value retrieval unit 241 is also input to the data generation unit 264. Raw teaching data output from the data generation unit 264 are stored in the robot teaching database 229.

The second robot data generation unit 230 includes a data reading unit 231, a teaching function 232, a data copy function 233, a work sharing function 234, a robot coordination function 235, a data generation unit 236 (in FIG. 7, described as “three-dimensional position (X, Y, Z) . . . ”), a robot data reading/storage unit 237, robot controller links 238 corresponding to the n arm robots 200-1 to 200-n. Parameter priority and limitation data 222a is a part of the second input data 222 (see FIG. 6), and specifies various parameters, priorities, limitations, and so on. The parameter priority and limitation data 222a is input to the data reading unit 231.

The data generation unit 236 calculates coordinates of three-dimensional position X, Y, Z for each of the n arm robots 200-1 to 200-n, and generates robot teaching data θ1 to θn that are raw teaching data. The data generation unit 236 calculates correction values Δθ1 to Δθn of the robot teaching data, and calculates robot teaching data θ1′ to θn′ supplied to the respective arm robots 200-1 to 200-n based on the robot teaching data θ1 to θn that are raw teaching data and the correction values Δθ1 to Δθn.

The robot data reading/storage unit 237 inputs/outputs data such as axial position data, operation modes, and tool control data about the n arm robots 200-1 to 200-n to/from the robot teaching database 229.

The n arm robots 200-1 to 200-n each include a robot controller 252, a robot mechanism 253, and an actuator 254 for the robot hand 202 (see FIG. 6). However, FIG. 7 shows an internal configuration of only the arm robot 200-1. The n robot controllers 252 are linked to the robot controller links 238 in the second robot data generation unit 230, and exchanges various signals therebetween. In each of the arm robots 200-1 to 200-n, the robot controllers 252 controls the respective robot mechanisms 253 and actuators 254.

When an object is picked from the storage shelf in real time, the sensor 206 detects a relative position between the object 203 or a stocker 212 and the actuator 254. The detected relative position is output as the above-mentioned static correction value 228, and is also output to the robot position correction value calculation unit 226.

### <Operational Configuration of Coordinate System Data>

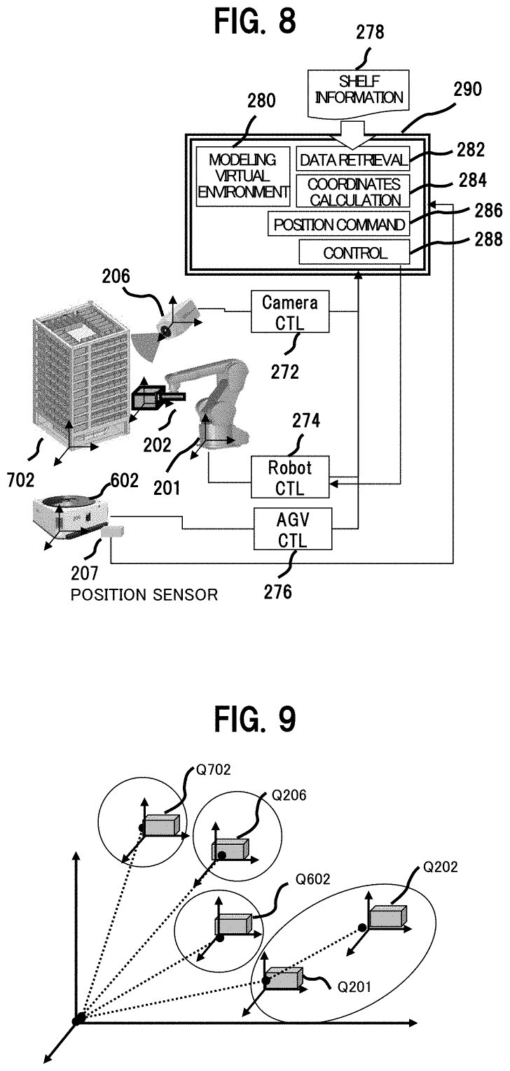

FIG. 8 is a view showing a control configuration of off-line teaching and robot operation track correction.

In the present embodiment, picking are related to five elements: the transfer robot 602, the storage shelf 702, the sensor 206, the robot body 201, and the robot hand 202. Thus, FIG. 8 shows these five elements. In FIG. 8, a coordinate system calculation unit 290 includes a modeling virtual environment unit 280, a data retrieval unit 282, coordinate calculation unit 284, a position command unit 286, and a control unit 288. The coordinate system calculation unit 290 handles coordinates of the above-mentioned five elements in an absolute coordinate system.

The coordinates of the transfer robot 602 among the above-mentioned five elements are measured by a position sensor 207. Here, a LiDAR sensor that measures the distance to a surrounding object (including the transfer robot 602) may be used as the position sensor 207. The operation status and position of the transfer robot 602 are controlled by an AVG controller 276. Position data on the robot body 201 of the arm robot 200 are retrieved in advance. The coordinates of the robot hand 202 during the operation of the arm robot 200 are measured by a sensor such as an encoder. When the coordinates of the robot hand 202 are measured, the information is supplied to the coordinate system calculation unit 290 in real time, and the position of the robot hand 202 is controlled via a robot controller 274.

The camera included in the sensor 206 is controlled by a camera controller 272. The position data on the stopped sensor 206 are retrieved into the coordinate system calculation unit 290 in advance. When the sensor 206 is scanning surroundings, the coordinates of the sensor 206 are supplied from the camera controller 272 to the coordinate system calculation unit 290 in real time. Shelf information 278 is supplied to the coordinate system calculation unit 290. The shelf information 278 specifies the shape and dimensions of the storage shelf 702.

The camera included in the sensor 206 takes an image of the storage shelf 702. The modeling virtual environment unit 280 of the coordinate system calculation unit 290 models the storage shelf 702 based on the shelf information 278 and the image of the storage shelf 702. The coordinate calculation unit 284 calculates the coordinates of the above-mentioned five elements based on data such as a modeling result of the modeling virtual environment unit 280. The control unit 288 calculates a position command to each of the transfer robot 602, the robot body 201, the robot hand 202, the sensor 206, and the storage shelf 702 based on calculation results of the coordinate calculation unit 284.

FIG. 9 is a schematic view showing absolute coordinates obtained by the coordinate calculation unit 284 (see FIG. 8). In FIG. 9, transfer robot coordinates Q602, storage shelf coordinates Q702, sensor coordinates Q206, robot body coordinates Q201, and robot hand coordinates Q202 indicate absolute coordinates of the transfer robot 602, the storage shelf 702, the sensor 206, the robot body 201, and the robot hand 202, respectively.

Among them, the absolute coordinates of the storage shelf coordinates Q702, robot body coordinates Q201, and the robot hand coordinates Q202 may be calculated by the above-mentioned off-line teaching, in consideration of various situations (for example, type of the storage shelf 702, type of the robot body, and type of the robot hand).

Each of the coordinates Q201, Q202, Q206, Q602, and Q702 obtained by off-line teaching is referred to as coordinates “model value”. At operation of the transfer robot 602 and the arm robot 200, position data are retrieved from the transfer robot 602, the robot body 201, the robot hand 202, and the sensor 206, and differences between the data and the model value are calculated. Based on the calculated differences, the raw teaching data (robot teaching data e1 to en) are corrected in real time to obtain teaching data.

With such configuration, off-line teaching for various objects may be performed to increase the working efficiency (robot teaching and so on) and improve the working quality due to higher positional accuracy.

### <Operational Configuration of Collection and Inspection Area>

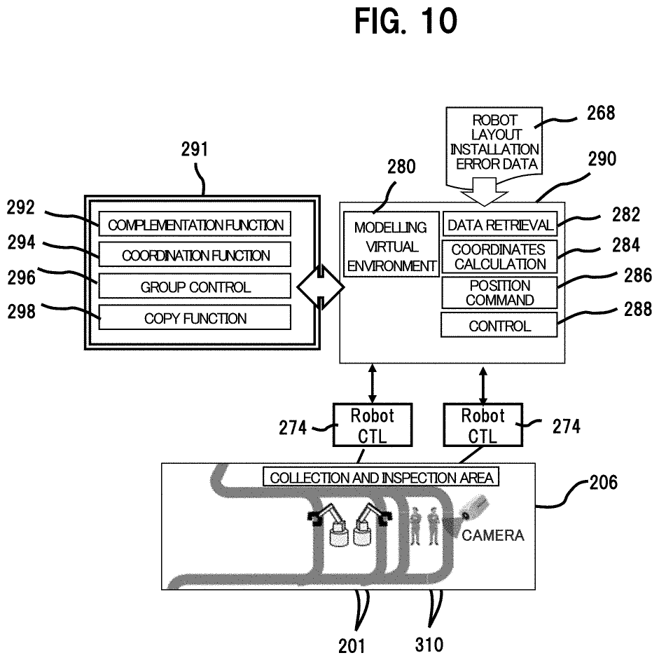

FIG. 10 is block diagram showing the configuration in which off-line teaching for the arm robot 200 is performed in the collection and inspection area 106 (see FIG. 1). The constituents having the same configuration and effect in FIG. 10 as those in FIGS. 1 to 9 are given the same reference numerals, and description thereof may be omitted.

In FIG. 10, an addition calculation unit 291 includes a complementation functional unit 292, a coordination functional unit 294, a group control unit 296, and a copy function unit 298.

The addition calculation unit 291 inputs/outputs data to/from the coordinate system calculation unit 290. Layout installation error data 268 of individual robot are also input to the coordinate system calculation unit 290. In this manner, teaching data for the arm robot 200 in the collection and inspection area 106 may be created offline.

With such configuration, off-line teaching for more variety of objects may be performed to increase the working efficiency (robot teaching and so on) and improve the working quality due to higher positional accuracy.

The configuration shown in FIG. 10 may be applied to the arm robot 200 in the packing area 107.

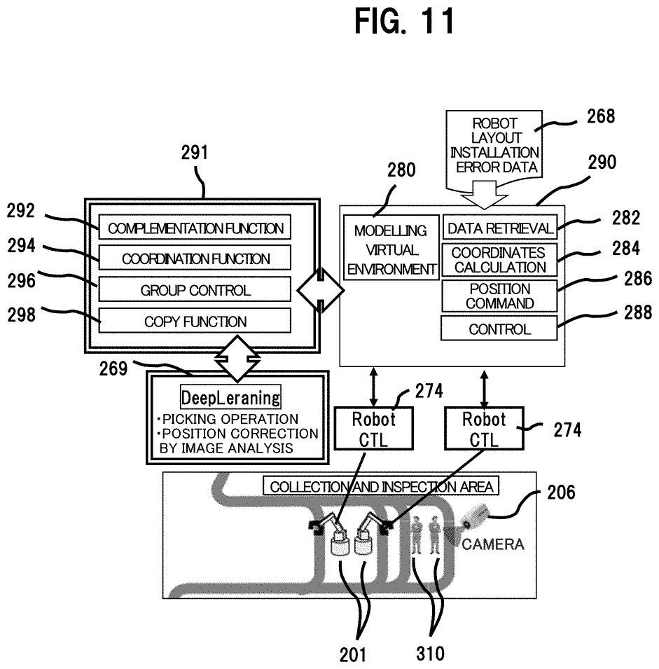

FIG. 11 is a block diagram showing another configuration in which off-line teaching for the arm robot 200 is performed in the collection and inspection area 106 (see FIG. 1).

In the configuration shown in FIG. 11, in addition to the configuration shown in FIG. 10, a deep learning processing unit 269 is provided. The deep learning processing unit 269 exchanges data with the coordinate system calculation unit 290 and the addition calculation unit 291 to execute artificial intelligence processing by deep learning.

With such configuration, off-line teaching for more variety of objects may be performed to increase the working efficiency (robot teaching and so on) and improve the working quality due to higher positional accuracy.

Like the configuration shown in FIG. 10, the configuration shown in FIG. 11 may be also applied to the arm robot 200 in the packing area 107.

As described above, the configuration shown in FIGS. 6 to 11 includes: the robot teaching database (229) that stores raw teaching data (robot teaching data θ1 to θn) that is teaching data for the arm robot (200) based on the storage shelf coordinates model value (Q702) that is the three-dimensional coordinates model value of the storage shelf (702) and the robot hand coordinates model value (Q202) that is the three-dimensional coordinates model value of the robot hand (202); the sensor (206) that detects the relative positional relationship between the storage shelf (702) and the robot hand (202); and the robot data generation unit (264, 230) that corrects the raw teaching data based on a detection result of the sensor (206) to generate the robot teaching data (81′ to θn′) to be supplied to the arm robot (200).

With such configuration, the raw teaching data (robot teaching data θ1 to θn) is the teaching data for the arm robot (200) based on the sensor coordinates model value (Q206) that is the three-dimensional coordinates model value of the sensor (206), the transfer robot coordinates model value (Q602) that is the three-dimensional coordinates model value of the transfer robot (602), and the robot body coordinates model value (Q201) that is the three-dimensional coordinates model value of the robot body (201), in addition to the storage shelf coordinates model value (Q702) and the robot hand coordinates model value (Q202).

Thereby, off-line teaching for various objects may be performed to increase the working efficiency and improve the working quality due to higher positional accuracy. This may correctly manage the inventory state of the individual objects.

### [Transfer in Zone/Autonomous Control of Arm Robot]

### <Summary of Autonomous Control>

When operation control of the transfer robot is performed by simulation in the zone 12 or the like shown in FIG. 2, operation control of the arm robot 200 (see FIG. 1) may be preferably performed.

Thus, in the present embodiment, simulation of the arm robot 200 in the zone is performed to reduce the picking time, thereby increasing shipments per unit time.

The number of times of picking and shipments per unit time may be increased by performing more minute control, that is, autonomous control in unit of zone in consideration of in-zone equipment characteristics (for example, singularities of the arm robot 200 and the operation sequence giving a high priority to workability).

Specifically, the warehouse system 300 may perform simulation of the transfer robot 602 and the arm robot 200 to execute the efficient operation sequence, thereby efficiently controlling the transfer robot and the arm robot in each zone.

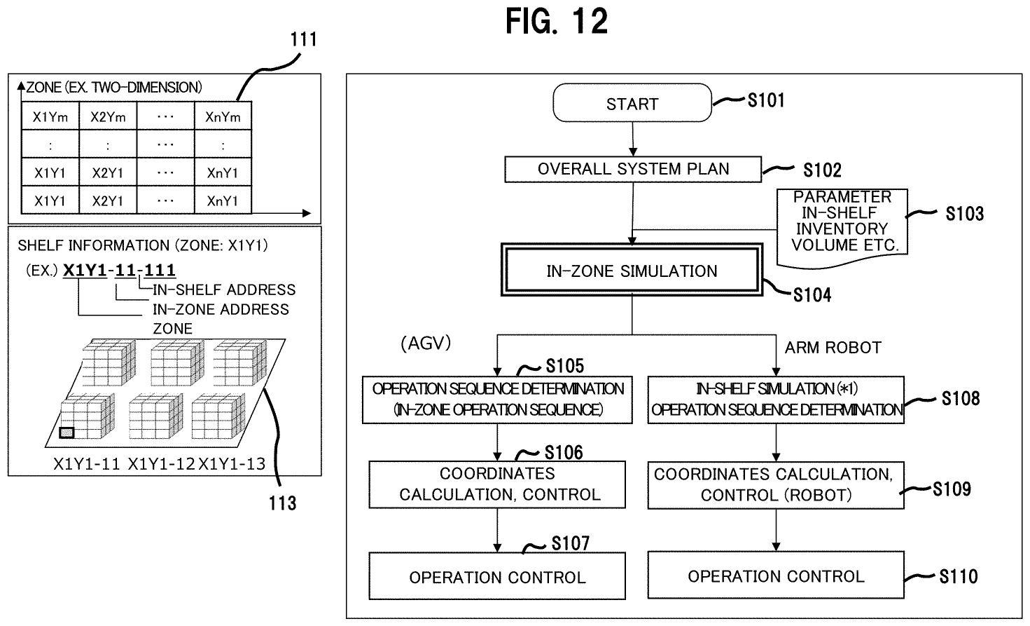

FIG. 12 is a flow chart of simulation performed in each zone by the central controller 800 (see FIG. 1). In the present embodiment, simulation is performed in the zone before bringing an actual picking system into operation. The simulation includes (1) establishment of the autonomous operation sequence for the transfer robot (Steps S105 to S107) and (2) in-shelf simulation of the arm robot (Steps S108 to S110).

When the processing starts in Step S101 in FIG. 12, the processing proceeds to Step S102, and the central controller 800 simulates the plan of the whole warehouse system. Next, when the processing proceeds to Step S103, the central controller 800 receives data on the inventory volume in the shelf as parameters. Next, when the processing proceeds to Step S104, the central controller 800 starts in-zone simulation. Hereinafter, the processing in Steps S105 to S107 and the processing in Steps S108 to S110 are executed in parallel.

First, when the processing proceeds to Step S105, the central controller 800 determines the operation sequence for the transfer robot. That is, the operation sequence in the related zone is determined. Next, when the processing proceeds to Step S106, the central controller 800 performs coordinate calculation and coordinate control for the transfer robot. Next, when the processing proceeds to Step S107, the central controller 800 performs operation control for the transfer robot.

When the processing proceeds to Step S108, the central controller 800 performs in-shelf simulation of the arm robot. In other words, the operation sequence is determined. At this time, the central controller 800 uses the off-line teaching technique to perform in-shelf simulation. Next, when the processing proceeds to Step S109, the central controller 800 performs coordinate calculation and coordinate control for the arm robot. Next, when the processing proceeds to Step S110, the central controller 800 performs operation control for the arm robot.

Particular two-dimensional coordinates 111 are previously set to two-dimensional coordinates in the zone. As shelf information 113 on a certain object, a zone to which the storage shelf belongs, an address in the zone to which the storage shelf belongs, and a position of the object in the storage shelf are set.

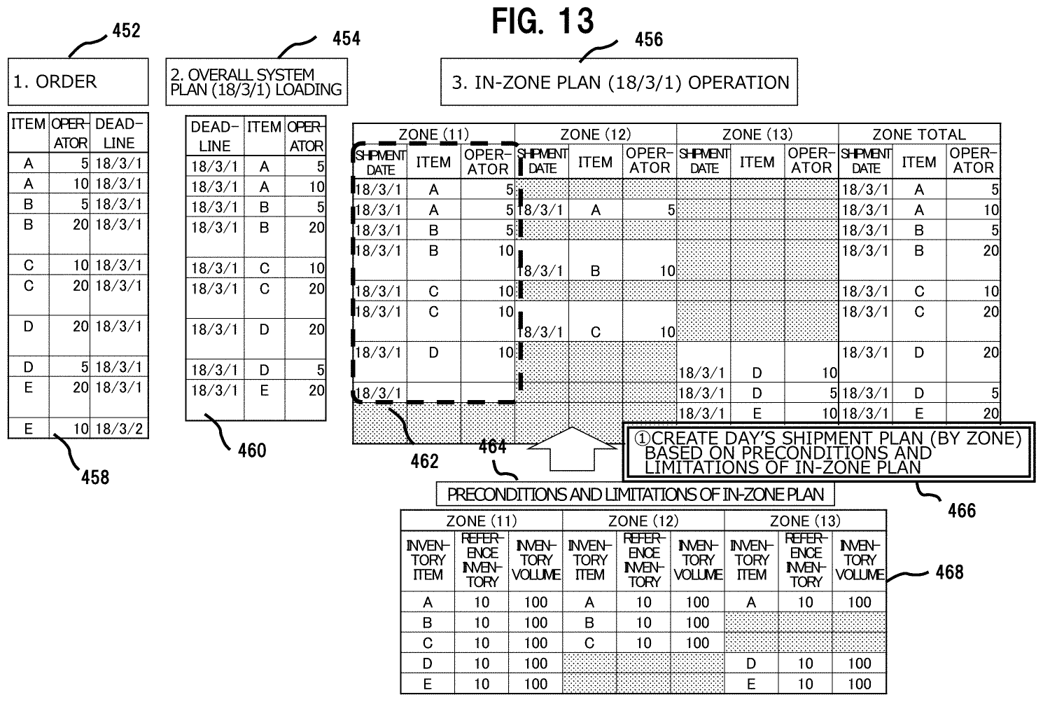

FIG. 13 is an explanatory view of a transfer robot operation sequence as a result of autonomous control simulation in unit of zone.

It is assumed that the warehouse system 300 (see FIG. 1) receives an order list data 458 as an order 452 of the object (object). In the state where shipment list data 460 is decided as shipment 454 shipped from the warehouse system, precondition and limitation data 468 of in-zone plans of the zones 11, 12, and 13 are settled and considered.

As a result, in the present embodiment, autonomous control simulation of the transfer robot demonstrates that, when the storage shelf is moved and taken out of each zone by the transfer robot, the target object may be efficiently picked from the zone 11 surrounded with a dotted line if possible, in consideration of the moving distance and the number of times of movement of the transfer robot as objective functions.

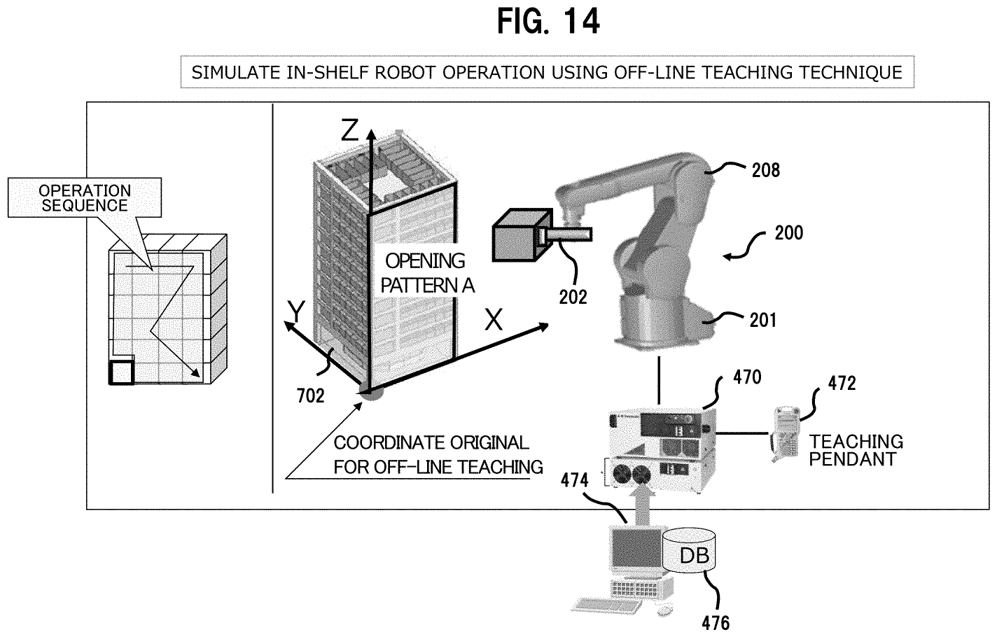

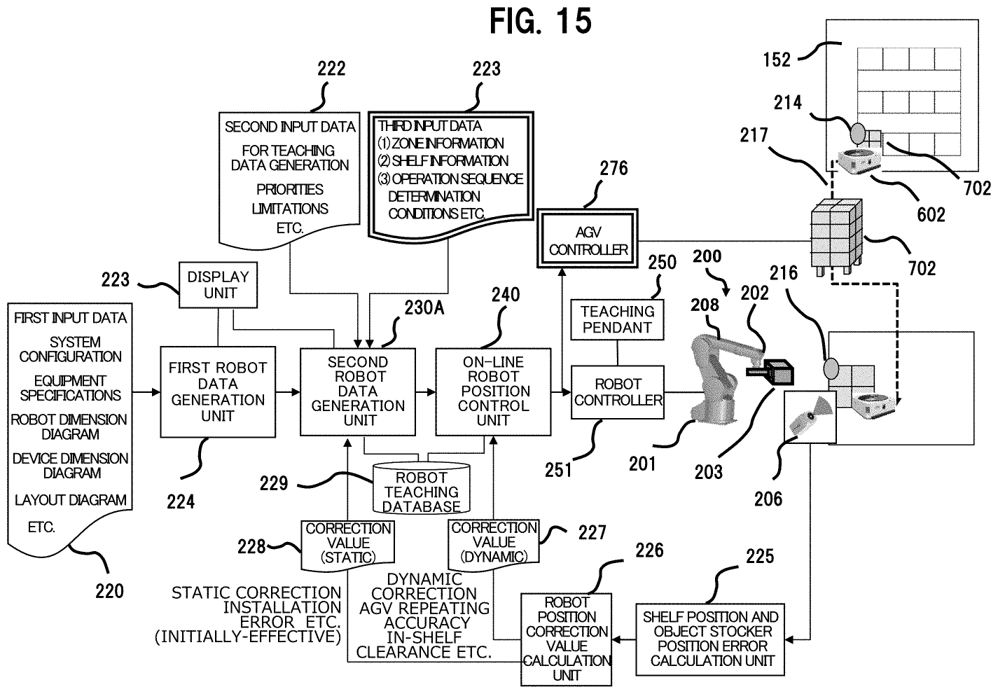

FIG. 14 is an explanatory view showing operations of off-line teaching for the arm robot 200.

For off-line teaching for the arm robot 200, a control computer 474 that installs software dedicated to off-line teaching therein is provided. A database 476 stored in the control computer 474 contains (1) point, (2) path, (3) operation mode (interpolation type), (4) operation rate, (5) hand position, (6) operation conditions as teaching data.

The arm robot 200 is caused to perform learning using a dedicated controller 470 and a teaching pendant 472. As an example of learning, for example, the arm robot learns off-line so as to increase the working efficiency by setting the moving distance and the number of times of movement of the robot arm 208 and the robot hand 202 as objective functions. In other words, in taking the object out of the storage shelf 702, the robot arm 208 learns off-line the operation sequence of efficiently moving the robot hand 202 from any opening.

FIG. 15 is a block diagram showing another configuration of off-line teaching and robot operation track correction in the present embodiment. In FIG. 15, unless otherwise specified, the constituents having the same reference numerals as in the example of FIG. 6 have similar configurations and effects.

As compared with the configuration in FIG. 6, the configuration in FIG. 15 includes AGV controller 276, and a second robot data generation unit 230A (robot data generation unit) in place of the second robot data generation unit 230. Third input data 223 are supplied to the second robot data generation unit 230A.

Here, the third input data 223 contains (1) zone information, (2) shelf information, and (3) operation sequence determination conditions. The AGV controller 276 decides (1) the autonomous operation sequence of the transfer robot 602 and (2) the operation sequence obtained by in-shelf simulation of the arm robot 200 to control operations of the transfer robot 602 in real time.

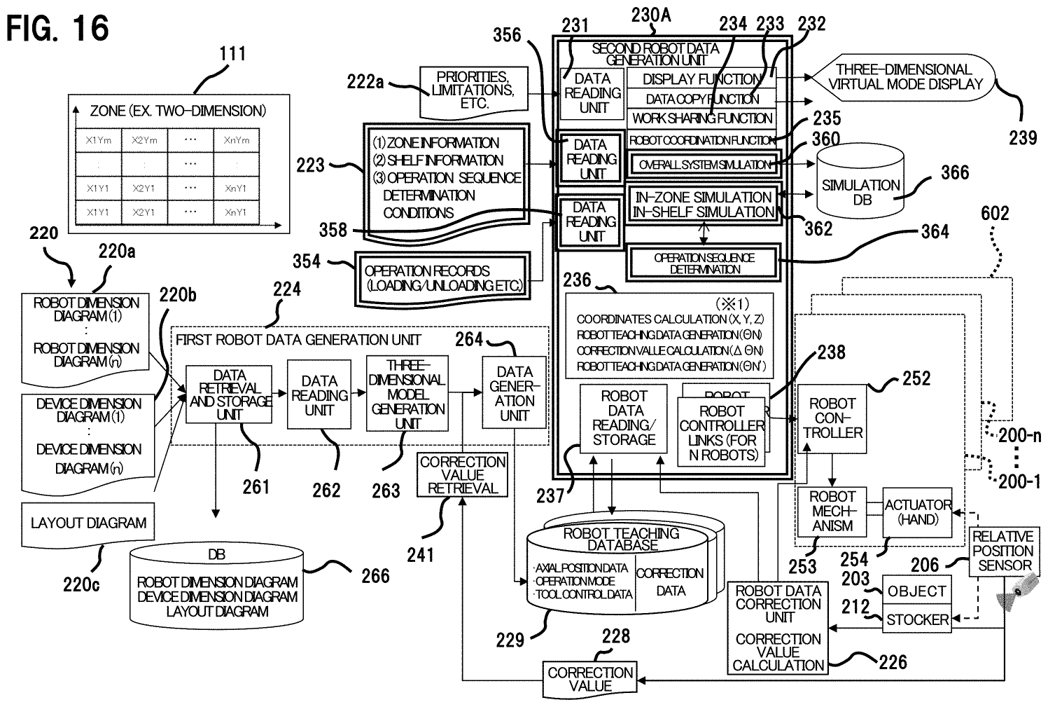

FIG. 16 is a block diagram showing a detailed configuration of the second robot data generation unit 230A in FIG. 15.

In FIG. 16, unless otherwise specified, the constituents having the same reference numerals as in FIG. 7 have similar configurations and effects.

As described above, the second input data 222 and the third input data 223 are input to the second robot data generation unit 230A. Operation record data 354 are also input to the second robot data generation unit 230A. Here, the operation record data 354 are data indicating loading/unloading records of various objects.

The second input data 222, the third input data 223, and the operation record data 354 are read by the second robot data generation unit 230A via the data reading unit 231, 356, 358, respectively. The second robot data generation unit 230A includes an overall system simulation unit 360 and an in-zone simulation and in-shelf simulation unit 362. The overall system simulation unit 360 and the in-zone simulation and in-shelf simulation unit 362 input/output data to/from a simulation database 366 and finally, the operation sequence determination unit 364 determines the overall control sequence including the transfer robot 602 and the arm robot 200.

With such configuration, (1) the autonomous operation sequence of the transfer robot 602 and (2) the operation sequence obtained by in-shelf simulation of the arm robot 200 are determined to achieve high-speed and high-accuracy control.

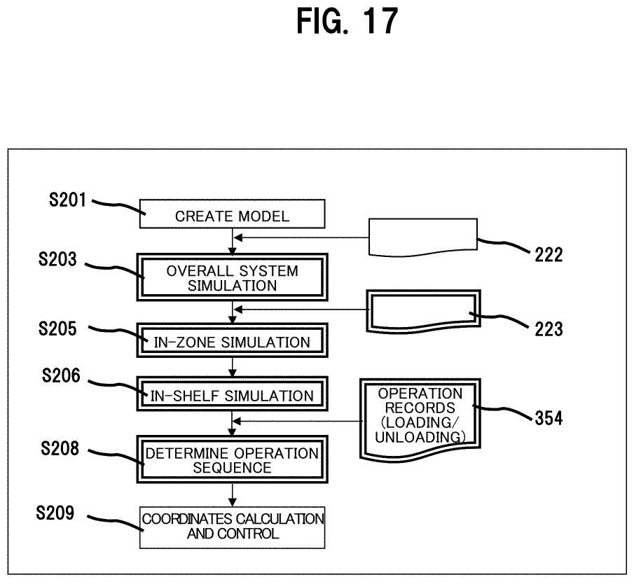

FIG. 17 is a flow chart of processing executed by the second robot data generation unit 230A.

In FIG. 17, when the processing proceeds to Step S201, the second robot data generation unit 230A creates a model of the warehouse system 300. Next, when the processing proceeds to Step S203, the second robot data generation unit 230A performs simulation of the overall warehouse system 300 based on the model created in Step S201 and the second input data 222 (priorities, operation order, limitations, information on obstacle, inter-robot work sharing rules, and so on).

Next, when the processing proceeds to Step S205, the second robot data generation unit 230A performs in-zone simulation based on a result of the simulation in Step S203 and the third input data 223 (zone information, shelf information, operation sequence determination conditions, and so on). Next, when the processing proceeds to Step S206, the second robot data generation unit 230A performs in-shelf simulation.

Next, when the processing proceeds to Step S208, the second robot data generation unit 230A determines an operation sequence based on the in-shelf simulation result in Step S206 and the operation record data 354 (loading/unloading records of various objects). Next, when the processing proceeds to Step S208, the second robot data generation unit 230A performs coordinate calculation and various type of control based on the processing results in Steps S201 to S208.

Thereby, the second robot data generation unit 230A performs simulation of the transfer robot 602 and the arm robot 200 in the warehouse system 300 to achieve the efficient operation sequence. This can efficiently control the transfer robot 602 and the arm robot 200 in each zone.

As described above, the configuration shown in FIGS. 12 to 17 includes: transfer robots (602) that each are assigned to any zone (11, 12, 13) and transfers the storage shelf (702) together with the object (203) from the assigned zone (11, 12, 13) to the operation range of the arm robot (200); and the controller (800) that performs simulation of loading the object (203) for each of the zones (11, 12, 13) (S104) when the object to be unloaded is designated, and determines the zone (11, 12, 13) subjected to the unloading processing of the object (203) based on the result of the simulation.

With such configuration, the controller (800) determines the zone in which the moving distance or the number of times of movement of the transfer robot (602) is smallest among the plurality of zones (11, 12, 13) as the zone (11, 12, 13) subjected to the unloading processing of the object (203), based on the result of the simulation.

Thereby, in each zone (11, 12, 13), the transfer robots (602) and the arm robot (200) may be efficiently controlled.

### [Box Pile-Up Sign Detection]

Next, a technique of predicting box pile-up in the line in the collection and inspection area 106 or the packing area 107 of the warehouse system 300 (see FIG. 1) will be described.

In the warehouse system 300 in the present embodiment, the sensors 206 are strategically installed in the conveyor line, and measure the pile-up status of the flowing containers. When detecting a congestion sign of the conveyor, the central controller 800 informs the sign to the information terminal (smart phone, smart watch, and so on) of the operator 310 in real time before actual pile-up to promote some action. Details will be described below.

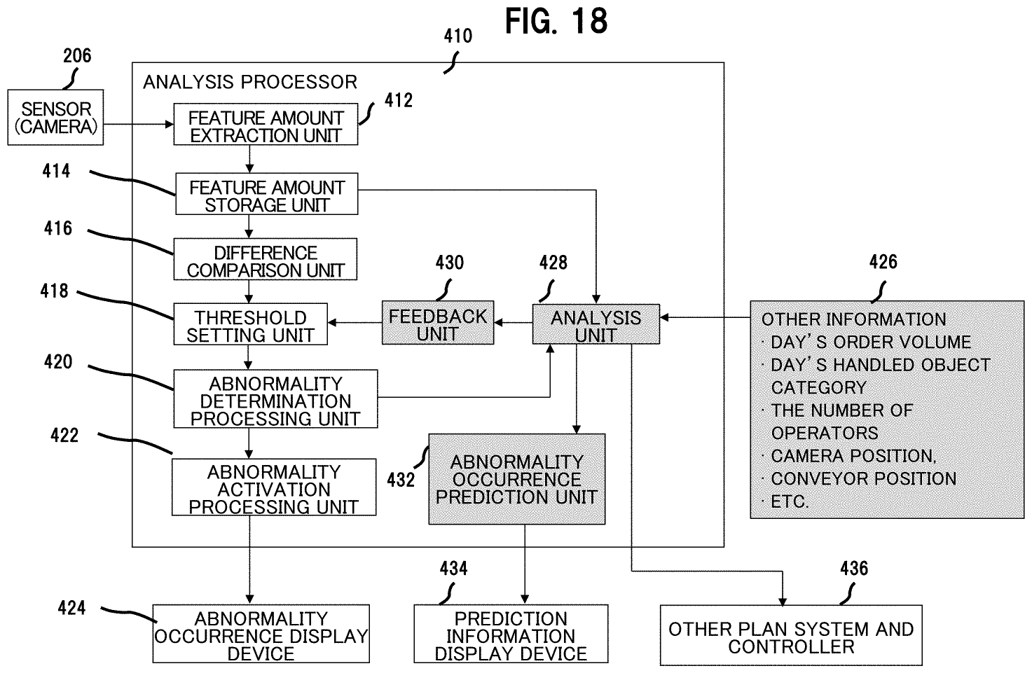

FIG. 18 is a block diagram showing an analysis processor 410 in the present embodiment. The analysis processor 410 may be separated from the central controller 800, or may be integrated with the central controller 800.

The analysis processor 410 includes a feature amount extraction unit 412, a feature amount storage unit 414, a difference comparison unit 416, a threshold setting unit 418, an abnormality determination processing unit 420, an abnormality activation processing unit 422, an analysis unit 428, a feedback unit 430, and an abnormality occurrence prediction unit 432.

Image data from the sensor 206 are sent to the feature amount extraction unit 412 of the analysis processor 410. The image data are sent to the feature amount storage unit 414 and then, are compared with a below-mentioned reference image by the difference comparison unit 416. Then, data are sent to the threshold setting unit 418, and the abnormality determination processing unit 420 determines a deviation from a threshold. The determination result of the abnormality determination processing unit 420 is supplied to the abnormality activation processing unit 422, and an abnormality occurrence display device 424 displays the supplied information.

To set a threshold and the like, other information 426 is supplied from the outside to the analysis unit 428. The other information 426 is information on, for example, day's order volume, day's handled object category, the number of operators, camera position, conveyor position. Data from the analysis unit 428 are supplied to the feedback unit 430. The threshold setting unit 418 sets a threshold based on the information supplied to the feedback unit 430.

The data from the feature amount storage unit 414 are also supplied to the analysis unit 428. A determination result of the abnormality determination processing unit 420 is also input to the analysis unit 428. Analysis data from the analysis unit 428 are sent to the abnormality occurrence prediction unit 432 as well as an external other plan system and controller 436. As a result, when an abnormality occurs, the abnormality occurrence may be informed to the abnormality occurrence display device 424. Here, the abnormality occurrence display device 424 to which the abnormality occurrence is informed may be, for example, an alarm light (not shown) in the warehouse system, the smart phone, smart watch, or the like of the operator 310, or so on.

When the abnormality occurrence is predicted, the abnormality occurrence prediction unit 432 supplies data indicating the predication to a prediction information display device 434. Thereby, the prediction information display device 434 may display, for example, the prediction status “pile-up will occur within X minutes”. Here, like the abnormality occurrence display device 424, the prediction information display device 434 that displays the prediction status may be the smart phone, smart watch, or the like of the operator 310.

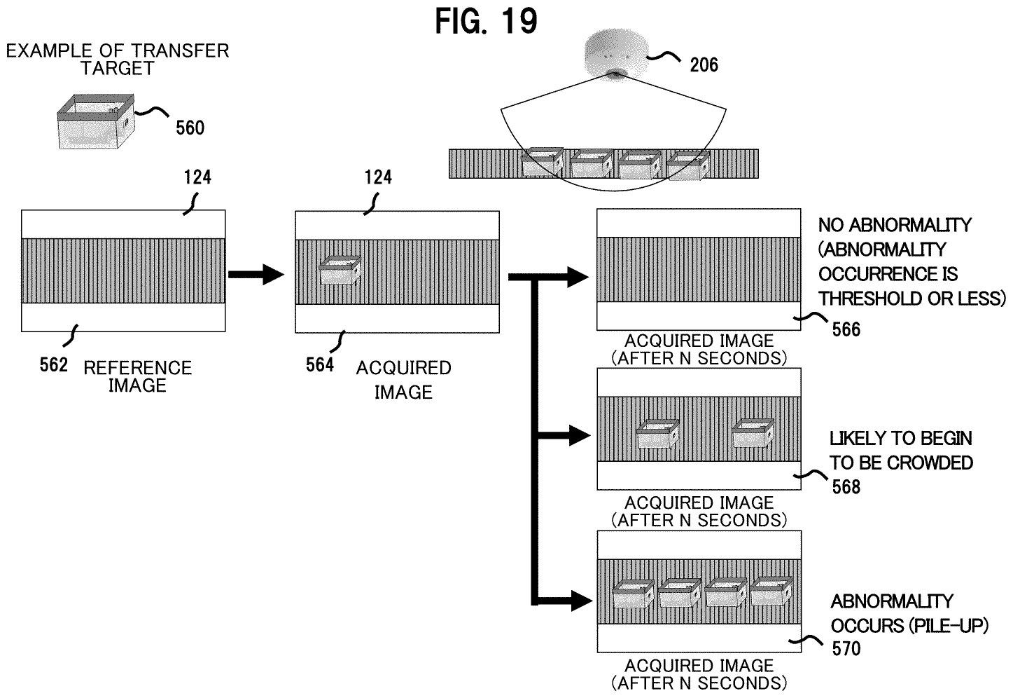

FIG. 19 is a schematic view showing operations of the analysis processor 410 in the present embodiment.

In the shown example shown in FIG. 19, a box-shaped container 560 (transfer target) is used as an example of transfer target. To detect and predict the pile-up of the containers 560, for example, an image of the transfer line 124 on which nothing is placed (no operation) is captured by the sensor 206. This image is referred to as a reference image 562. The feature amount of the reference image 562 is stored in the difference comparison unit 416 (see FIG. 18). An image of the transfer line 124 acquired during the operation of the warehouse system 300 is captured by the sensor 206. This image is referred to as an acquired image 564. The feature amount extraction unit 412 extracts the feature amount of the acquired image 564, and the extracted feature amount is supplied to the feature amount storage unit 414 and then, supplied to the analysis unit 428.

Next, after an elapse of n seconds, an image of the transfer line 124 is captured by the sensor 206. The image data at this time is also sent to the analysis unit 428, to find threshold values th1, th2 (not shown) for determining the abnormality occurrence. Here, the threshold value th1 is a threshold for determining the presence/absence of the possibility that the transfer line 124 begins to be crowded, and the threshold value th2 is a threshold for determining whether or not an abnormality has occurred. Accordingly, a relation of “th1<th2” holds.

Here, it is assumed that the threshold value th1 is “1” and the threshold value th2 is “3”. For example, since the number of container images is equal to or larger than the threshold value th1 in an acquired image 566 having the number of container images of “0”, the analysis processor 410 determines that “no abnormality occurs”. Although the number of container images is “1” in the above-mentioned acquired image 564, also in this case, the number of container images is equal to or smaller than the threshold value th1 and thus, the analysis processor 410 determines that “no abnormality occurs”

When the number of the number of container images exceeds the threshold value th1 and is less than threshold value th2, the analysis processor 410 determines that “it is likely to begin to be crowded”. For example, since the number of container images exceeds the threshold value th1 (=1) and is equal to or smaller than the threshold value th2 (=3) in an acquired image 568 having the number of container images of “2”, the analysis processor 410 determines that “it is likely to begin to be crowded”.

In this case, as described above, the analysis processor 410 informs that “it is likely to begin to be crowded” to the smart phone, smart watch, or the like of the operator 310.

When the number of container images exceeds the threshold value th2 (=3) as in an acquired image 570 shown in FIG. 19, the analysis processor 410 determines that “abnormality has occurred (containers 560 pile up)”.

In this case, as described above, the analysis processor 410 flashes an alarm light (not shown) in the warehouse system 300 and further, informs pile-up abnormality occurrence to the smart phone, smart watch, or the like of the operator 310. In this case, the transfer line 124 may be forcibly stopped.

Then, to avoid pile-up, for example, in the collection and inspection area 106, the operator 310 may reduce the number of containers 560 flowing in the line of the robot body 201 so as to pass a lot of containers 560 to the line where the operator 310 is present.

To avoid pile-up, the processing of passing the container 560 to another transfer line may be instructed by the central controller 800 without waiting for an instruction from the operator 310 or the like.

As described above, the configuration shown in FIGS. 18 and 19 includes: the plurality of transfer lines (120, 122, 124, 126, 130) that each transfer the transfer target (560); the sensor (206) that detects the state of one transfer line; and the analysis processor (410) that instructs the operator to transfer the transfer target (560) to another transfer line when the sensor (206) determines that the one transfer line is crowded.

In this configuration, when the number of transfer targets (560) exceeds the first threshold (th1), the analysis processor (410) informs the operator of that effect, and when the number of transfer targets (560) exceeds the second threshold (th2) that is larger than the first threshold (th1), the analysis processor (410) stops the related transfer line (124).

Thereby, the operator may reliably detect pile-up of the transfer targets (560), rapidly performing a proper action such as a line change.

### [Inspection Using Image]

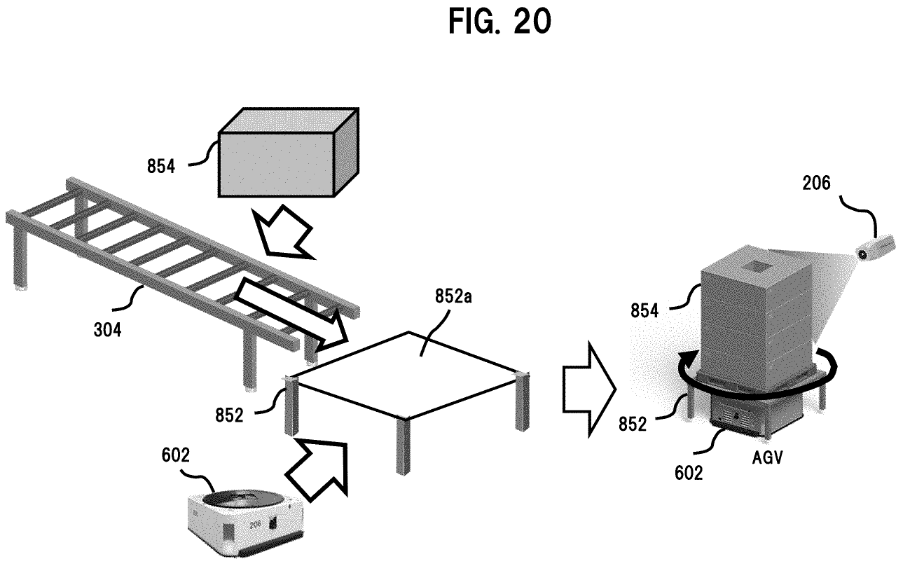

FIG. 20 is a schematic view showing a method of inspecting the loaded objects using the transfer robot 602 in the warehouse system 300. As shown in FIG. 2, the storage shelf 702 and so on are arranged in each of the zones 11, 12, and 13 in the warehouse 100. However, to store boxes that pack objects (for example, corrugated cardboard box) as they are, the space efficiency of the warehouse 100 may be increased by stacking these boxes rather than storing the boxed in the shelf. Thus, in the present embodiment, in place of some or all storage shelves 702, the dining table-shaped receiving base 852 as shown in FIG. 20 may be used. The receiving base 852 may be a palette.

Since an upper plate 852a of the receiving base 852 is a rectangular flat plate, a receiving object 854 (inspection target) such as a corrugated cardboard box may be placed on the upper plate. As in the case of the storage shelf 702, the transfer robot 602 enters below the receiving base 852 and pushes the upper plate 852a of the receiving base 852, thereby supporting and moving the receiving base 852.

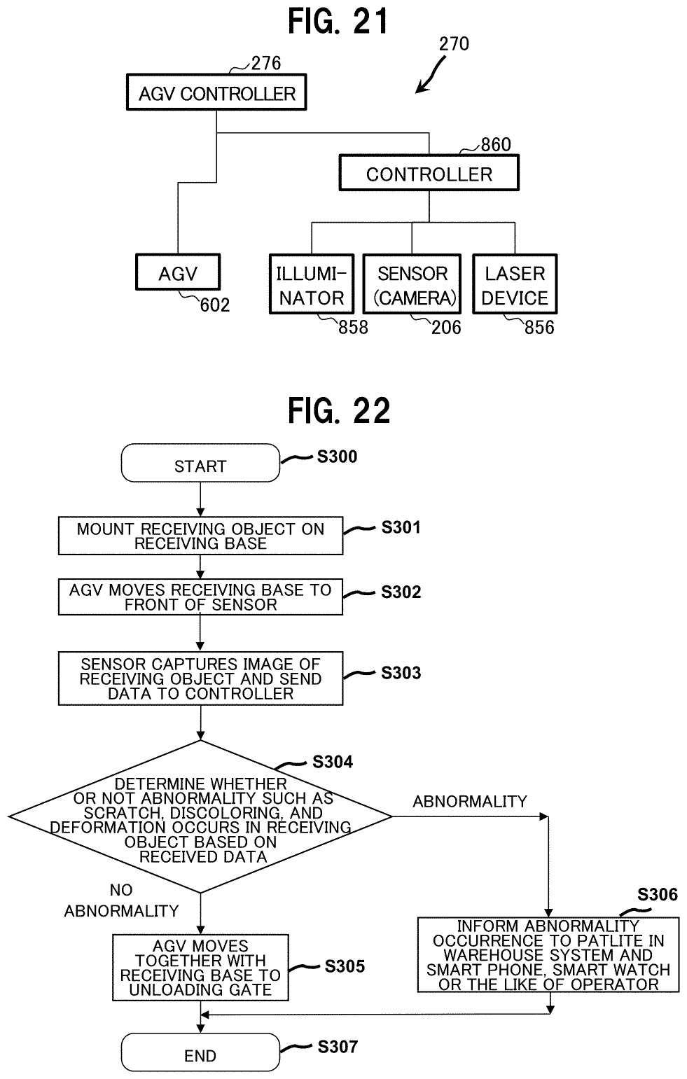

FIG. 21 is a block diagram showing an inspection system 270 applied to an inspection operation in the warehouse system 300.

In FIG. 21, the inspection system 270 includes an AGV controller 276, the transfer robot 602, a controller 860, an illuminator 858, a sensor 206, and a laser device 856. The controller 860 may be separated from the central controller 800, or may be integrated with the central controller 800. In response of a command from the AGV controller 276, the transfer robot 602 moves or rotates the receiving base 852 on which the receiving object 854 (see FIG. 20) is placed.

The command from the AGV controller 276 is also supplied to the controller 860 and in response to the command, the sensor 206 such as a camera operates to take an image of the receiving object 854. The controller 860 irradiates the receiving object 854 with strobe light using the illuminator 858, and irradiates the receiving object 854 with red lattice light (red lattice laser light) using the laser device 856. When the receiving object 854 is, for example, a cubic object such as a corrugated cardboard box, a red lattice image is projected onto the receiving object 854 using red lattice light.

Here, in a case where an abnormality such as“crushing” has occurred in the receiving object 854, since such an abnormality generates a strain in a lattice-shaped image, the abnormality of the receiving object 854 may be detected by taking the image with the sensor 206. When the illuminator 858 emits strobe light to generate a shadow on the receiving object 854, the abnormality of the receiving object 854 may be detected by the shape of the shadow as well. The inspection system 270 may automatically inspect the receiving object 854 in the middle of the transfer line where the transfer robot 602 transfers the receiving object 854. Accordingly, since it is no need to fix the inspection site at a particular place, the portability of the inspection site in the warehouse system 300 may be increased. In the example shown in FIG. 21, the inspection system 270 includes both the laser device 856 and the illuminator 858, but may include one of them.

When the sensor 206 is a camera, the sensor 206 may take an image of the receiving object 854, and reads product name, product code, the number of objects, expiration data, and lot No that are described on the receiving object 854, a bar code or two-dimensional code associated with related information, and product label and loading label that describe such information. Based on the read information, the controller 860 may perform the inspection operation of the inspection system 270. The sensor 206 is not limited to the camera, and may be an RFID reader, and read information on an RFID tag attached to the receiving object 854, thereby inspecting objects to be shipped.

FIG. 22 is a flow chart of inspection processing executed by the controller 860.

When the processing starts in Step S300 in FIG. 22, the processing proceeds to Step S301, and the receiving object 854 is mounted on the receiving base 852. That is, the receiving object 854 transferred from the outside by a truck or the like is placed on a conveyor 304 and then, is sent to the upper side of the receiving base 852. Generally, the plurality of receiving objects 854 are mounted on the receiving base 852.

Next, when the processing proceeds to Step S302, under control of the controller 860, the transfer robot 602 moves the receiving base 852 to the front of the sensor 206. That is, the transfer robot 602 enters below the receiving base 852, and lifts the receiving object 854 including the receiving base 852. With placed on the receiving base 852, the receiving object 854 is transferred to a place where it may be photographed using the camera of the sensor 206.

Next, when the processing proceeds to Step S303, in response to a command from the controller 860, the transfer robot 602 rotates in front of the sensor 206 by 360 degrees. The sensor 206 captures an image of the receiving object 854 at this time, and transmits the captured image to the controller 860.

Next, when the processing proceeds to Step S304, based on the captured image, the controller 860 determines whether or not an abnormality (scratch, discoloring, deformation, and so on) occurs in the receiving object 854.

When the determination result in Step S304 is “No”, the processing proceeds to Step S305. Here, under control of the controller 860, the transfer robot 602 moves together with receiving base 852 to the loading gate 320 (see FIG. 2). On the contrary, when the determination result in Step S304 is “Yes”, the processing proceeds to Step S306. Here, the controller 860 turns on an alarm light (not shown) in the warehouse system 300. The controller 860 informs the abnormality occurrence to the information terminal (smart phone, smart watch, or the like) of the operator 310, and moves the receiving base 852 and the receiving object 854 to a place other than the loading gate 320.

As described above, the configuration shown in FIGS. 20 to 22 includes: the dining table-shaped receiving base (852) having the upper plate (852a), the sensor (206) that detects the state of the inspection target (854) placed on the upper plate (852a); the transfer robot (602) that enters below the receiving base (852) and pushes the upper plate (852a) upwards to support and move the receiving base (852); and a controller (860) that horizontally rotates the transfer robot (602) supporting the receiving base (852), provided that the inspection target (854) is located to be inspected by the sensor (206).

The configuration further includes an irradiation device (858, 856) that irradiates the inspection target (854) with light, and the controller (860) determines the state of the inspection target (854) based on a result of irradiation of the inspection target (854) with light.

Thereby, the presence/absence of abnormality of the inspection target (854) may be detected with high accuracy.

### [Efficient Shelf Arrangement]

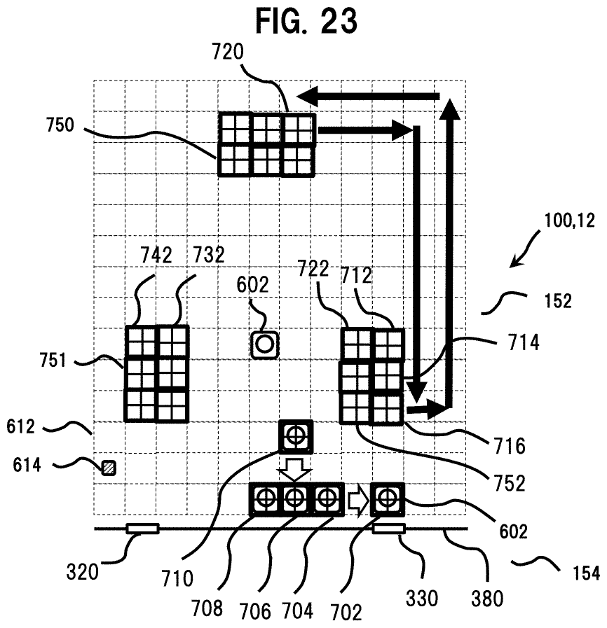

FIG. 23 is a plan view of the zone 12 and an explanatory view showing of efficient arrangement of the storage shelves.

In FIG. 23, an island 750 is formed in the zone 12, and contains a storage shelf 720. The other configuration of the zone 12 is similar to the configuration shown in FIG. 2. However, an island having six storage shelves including storage shelves 732, 742 is referred to as “an island 751”, and an island having six storage shelves including storage shelves 712, 714 is referred to as “an island 752”.

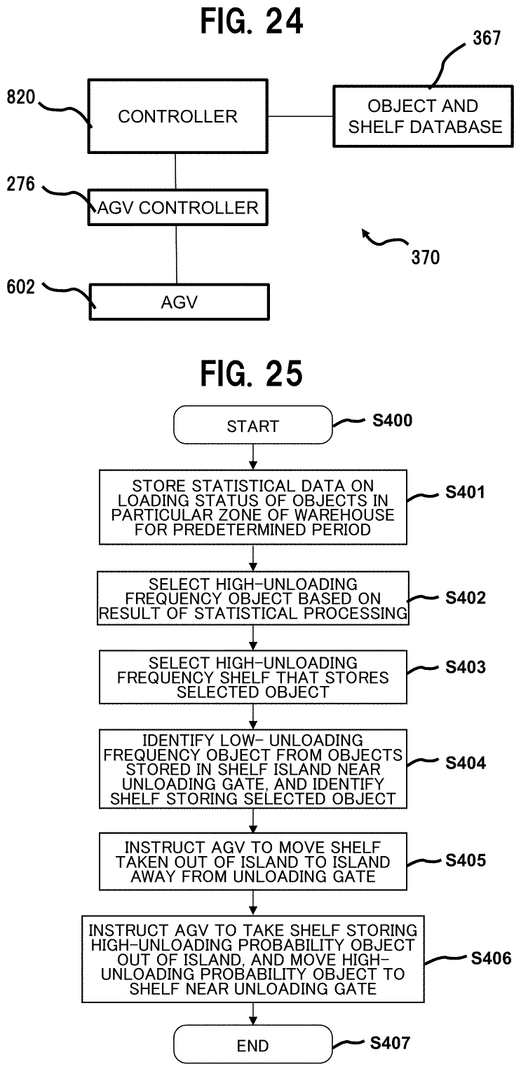

FIG. 24 is a block diagram showing a storage shelf interchange system 370 applied to interchange processing of the storage shelves in the warehouse system 300.

In FIG. 24, the storage shelf interchange system 370 includes a controller 820, the AGV controller 276, the transfer robot 602, and an object and shelf database 367. The controller 820 may be separated from the central controller 800, or may be integrated with the central controller 800.

The object and shelf database 367 stores object unloading probability data on the unloading probability of the various objects 203, and storage shelf unloading probability data on the unloading probability of each storage shelf.

Referring to the object and shelf database 367, the controller 820 determines a pair of interchanged storage shelves. In the example shown in FIG. 22, the determined storage shelves are a storage shelf 716 (first storage shelf) and a storage shelf 720 (second storage shelf). The controller 820 specifies the pair of determined storage shelves to the AGV controller 276, and causes the AGV controller to interchange the storage shelves.

FIG. 25 is a flow chart of shelf arrangement routine performed by the controller 820.

When the processing starts in Step S400 in FIG. 25, the processing proceeds to Step S401. In Step S401, the controller 820 stores statistical data of the unloading status of the objects 203 (see FIG. 3) in a particular zone (FIG. 23 in the example shown in zone 12) in the warehouse 100 for a predetermined sample period.

Next, when the processing proceeds to Step S402, the controller 820 executes statistical processing on the statistical data, and selects the object 203 having a high unloading frequency based on the processing result. Next, when the processing proceeds to Step S403, the controller 820 selects the storage shelf having a high unloading frequency (hereinafter referred to as the high-frequency storage shelf) that stores the selected object 203. In the example shown in FIG. 23, the storage shelf 720 is the high-frequency storage shelf.

In the processing in Step S403, it is preferable to select the object 203 having a high unloading probability predicted for a future period, in addition to a high unloading frequency for a past certain sample period. Specifically, the unloading frequency predicted in future may be obtained in consideration of future season, weather, temperature, time, and trend, and the object 203 having a high unloading probability may be selected based on the prediction and further, the high-frequency storage shelf that stores the selected object 203 may be selected.

Next, when the processing proceeds to Step S404, the object having a low unloading frequency is selected from the objects 203 stored in the island near the unloading gate 330 (the island located nearest to the unloading gate 330 or within a predetermined distance from the unloading gate 330). In Step S404, the storage shelf that stores the object having a low unloading frequency (hereinafter referred to as low-frequency storage shelf) is selected. In the example shown in FIG. 23, the low-frequency storage shelf is the storage shelf 716.

Next, when the processing proceeds to Step S405, the controller 820 instructs the transfer robot 602 to take the low-frequency storage shelf out of the current island, and move the low-frequency storage shelf to an island located away from the unloading gate 330. In the example shown in FIG. 23, the storage shelf 716 that is the low-frequency storage shelf is taken from the island 752, and is moved to the island 750 located away from the unloading gate 330. Next, when the processing proceeds to Step S406, the controller 820 instructs the transfer robot 602 to take the high-frequency storage shelf out of the current island, and move the high-frequency storage shelf to an island near the unloading gate 330. In the example shown in FIG. 23, the storage shelf 720 that is the high-frequency storage shelf is taken from the island 750, and is moved to the island 752 near the unloading gate 330.

Through the above-mentioned processing, the storage shelf storing the object that is likely to be taken may be located near the unloading gate 330. This may reduce the distance of the storage shelf moved by the transfer robot 602 to shorten the picking time of the object 203.

In the above-mentioned example, the storage shelves are interchanged in the particular zone, but the transfer robot 602 may be operated across the all zones to interchange the storage shelves.

As described above, the configuration shown in FIGS. 23 to 25 includes: the plurality of storage shelves (716, 720) that are arranged in respective predetermined arrangement places on the floor surface (152) and each store the plurality of unloadable objects (203); the transfer robot (602) that, when unloading of any of the plurality of objects (203) is designated, transfers any storage shelf (716, 720) storing the designated object (203) to the unloading gate (330) provided at the predetermined position; and the controller (800) that predicts the frequencies with which the plurality of storage shelves (716, 720) are transferred to the unloading gate (330) based on records of past shipment of the plurality of objects (203), and when the frequency of a second storage shelf (720) is higher than the frequency of a first storage shelf (716) among the plurality of storage shelves (716, 720) and the arrangement place of the second storage shelf (716) is further from the unloading gate (330) than the arrangement place of the first storage shelf (720) is, to change the arrangement place of the first storage shelf (716) or the second storage shelf (720) such that the arrangement place of the second storage shelf (720) is closer to the unloading gate (330) than the arrangement place of the first storage shelf (716) is.

With such configuration, when the arrangement place of the first storage shelf (716) or the second storage shelf (720) is to be changed, the controller (800) interchanges the arrangement places of the first storage shelf (716) and the second storage shelf (720).

Thereby, the storage shelf storing the object that is likely to be taken may be located near the unloading gate. This may reduce the distance of the storage shelf moved by the transfer robot (602) to shorten the picking time of the object.

[Cooperation with Stacker Crane]

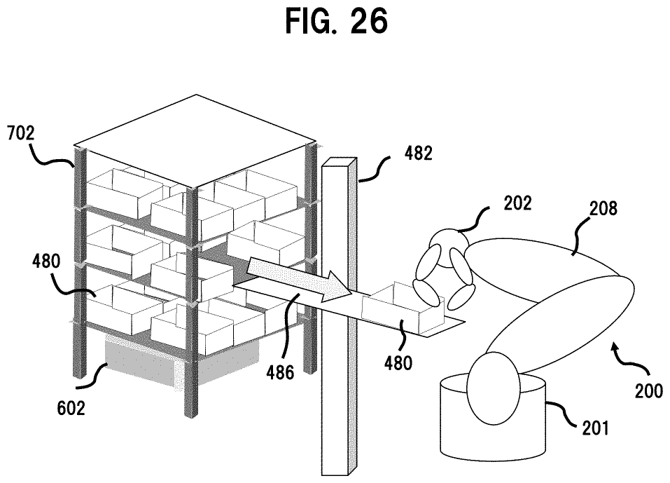

FIG. 26 is a schematic view showing a configuration in which a bucket 480 (bucket) is taken out of the storage shelf in the warehouse system 300.

The bucket 480 is a substantially cubic box placed on each storage shelf, with the upper surface opened. The bucket 480 generally stores a plurality of objects 203 of the same type (see FIG. 3).

In taking the bucket 480 out of the storage shelf 702, the bucket 480 may be picked and drawn using the robot hand 202 of the arm robot 200.

In FIG. 26, the arm robot 200 includes one robot arm 208 and one robot hand 202. In contrast, the arm robot may include two robot arms 208 and two robot hands 202. That is, one robot arm 208 may draw the bucket 480, and the other robot arm 208 may take the object 203 out of the bucket 480.

However, since control of the robot arm 208 takes much time, according to any of the above-mentioned techniques, it is difficult to speed up take-out of the object 203.

Thus, in the present embodiment, a stacker crane 482 for taking the bucket 480 out of the storage shelf 702 is provided. Here, the stacker crane 482 includes a drawing arm 486 that carries the bucket 480 into/out of the storage shelf 702, and has a function of moving the drawing arm 486 in horizontal direction with respect to the opposed surface of the storage shelf 702 and a function of vertically moving the drawing arm 486. The stacker crane 482 is provided at the unloading gate 330 (see FIG. 2).

The transfer robot 602 moves the storage shelf 702 that stores the target object to the front of the unloading gate 330. The buckets 480 stored in the storage shelf 702 are systematically classified according to type. Accordingly, in response to an instruction from the central controller 800, the stacker crane 482 may identify the bucket to be drawn. Thus, as compared to the case of driving the robot arm 208, the bucket 480 may be drawn from the storage shelf 702 rapidly and correctly.

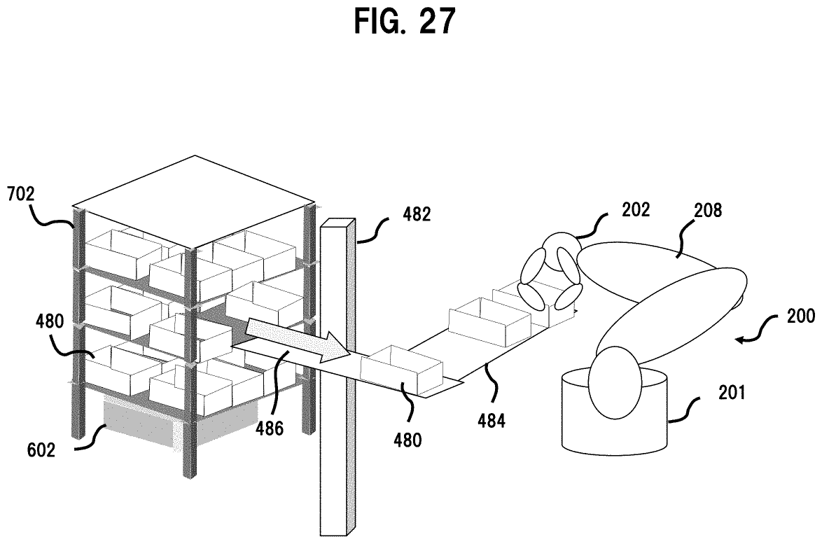

FIG. 27 is a schematic view showing another configuration in which the bucket 480 is taken out of the storage shelf in the warehouse system 300.

In the example shown in FIG. 27, a buffer shelf 484 that temporarily stores the bucket 480 taken by the stacker crane 482 is provided. That is, the buckets 480 taken by the stacker crane 482 is once stored in the buffer shelf 484. The arm robot 200 picks the object 203 from the bucket 480 placed on the buffer shelf 484.

In the example shown in FIG. 27, unlike the example in FIG. 26, (for example, a plurality of) buckets 480 for picking may be stored in the buffer shelf 484 and then, the arm robot 200 may perform picking. Although the picking time of the arm robot 200 varies according to the type and status of the target object 203, the picking time of the robot arm 208 may be made uniform by once holding the bucket 480 in the buffer shelf 484.

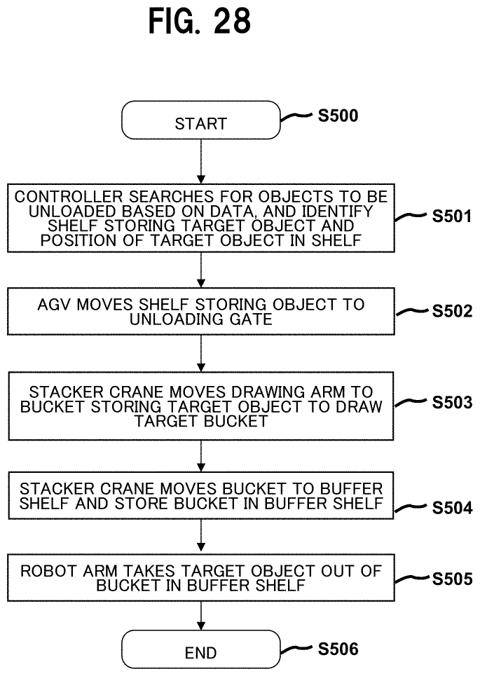

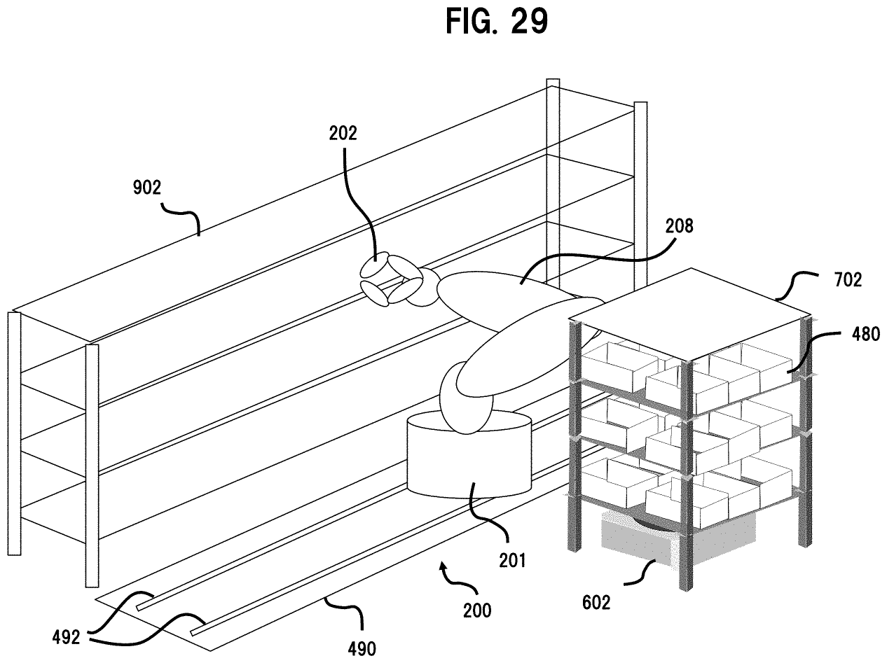

FIG. 28 is a flow chart of processing applied to the configuration shown in FIG. 27 by the central controller 800 (see FIG. 1).

When the processing starts in Step S500 in FIG. 28, the processing proceeds to Step S501. Here, the central controller 800 searches for the object 203 to be unloaded based on object data on the object stored in the warehouse 100, and identifies the storage shelf 702 that stores the target object, and the position of the object 203 in the storage shelf. Next, when the processing proceeds to Step S502, the central controller 800 causes the transfer robot 602 to move the storage shelf 702 that stores the object 203 to the unloading gate 330.

Next, when the processing proceeds to Step S503, the central controller 800 controls the stacker crane 482 to move the drawing arm 486 to the bucket 480 that stores the target object 203 and draws the target bucket 480. Next, when the processing proceeds to Step S504, under control of the central controller 800, the stacker crane 482 moves the target bucket 480 to the buffer shelf 484. Next, when the processing proceeds to Step S505, in response to a command from the central controller 800, the arm robot 200 takes the target object 203 out of the bucket 480 of the buffer shelf 484 using the robot arm 208 and the robot hand 202, and unloads the target object.

FIG. 28 is the flow chart applied to the configuration in FIG. 27, and in the configuration shown in FIG. 26, Step S504 may be skipped, and the other processing is the same as the above-mentioned processing. As described above, in the example shown in FIGS. 26 to 28, since the stacker crane 482 rather than the robot arm 208 takes the bucket 480 out of the storage shelf 702, picking may be performed more rapidly as compared to the case of using the robot arm 208.

As described above, the configuration shown in FIGS. 26 to 28 includes: the bucket (480) that stores the objects (203); the plurality of storage shelves (702) that are arranged in respective predetermined arrangement places on the floor surface (152) and store the plurality of unloadable objects (203) ina state of being stored in the bucket (480); the transfer robot (602) that, when unloading of any of the plurality of objects (203) is designated, transfers the storage shelf (702) storing the designated object (203) to the unloading gate (330) located at the predetermined position; the stacker crane (482) that is provided at the unloading gate (330) and takes the bucket (480) storing the designated object (203) out of the storage shelf (702); and the arm robot (200) that takes the designated object (203) out of the bucket (480) taken by the stacker crane (482).

The configuration in FIG. 27 further includes the buffer shelf (484) that holds the bucket (480) taken by the stacker crane (482), and the arm robot (200) takes the object (203) out of the bucket (480) held in the buffer shelf (484).

In this manner, the stacker crane (482) may take the object (203) out of the storage shelf (702), thereby achieving high-speed picking.

### [Movement of Sort Shelf by AGV]

FIG. 29 is a schematic view showing a configuration in which the target object is taken from the storage shelf 702 and stored in a sort shelf 902 at the unloading gate 330 (see FIG. 2). The sort shelf 902 sorts objects according to destination.

In the example shown in FIG. 29, two parallel rails 492 are lied on the floor surface. The robot body 201 includes wheels placed on the rails 492 and a motor for driving the wheels (not shown). Thus, the robot body 201 is movable along the rails 492. The bucket 480 storing the target object 203 is stored in the storage shelf 702. The arm robot 200 moves the robot arm 208 to the position opposed to the bucket 480.

Thereby, the arm robot 200 may pick the object with high working efficiency to move the target object to the sort shelf 902.

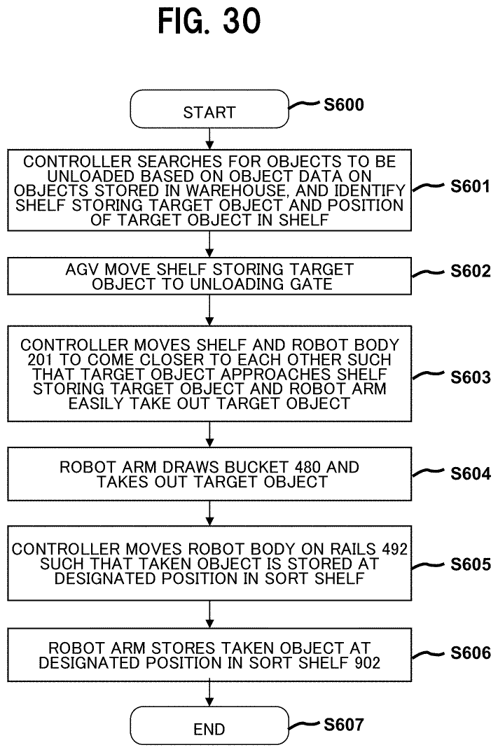

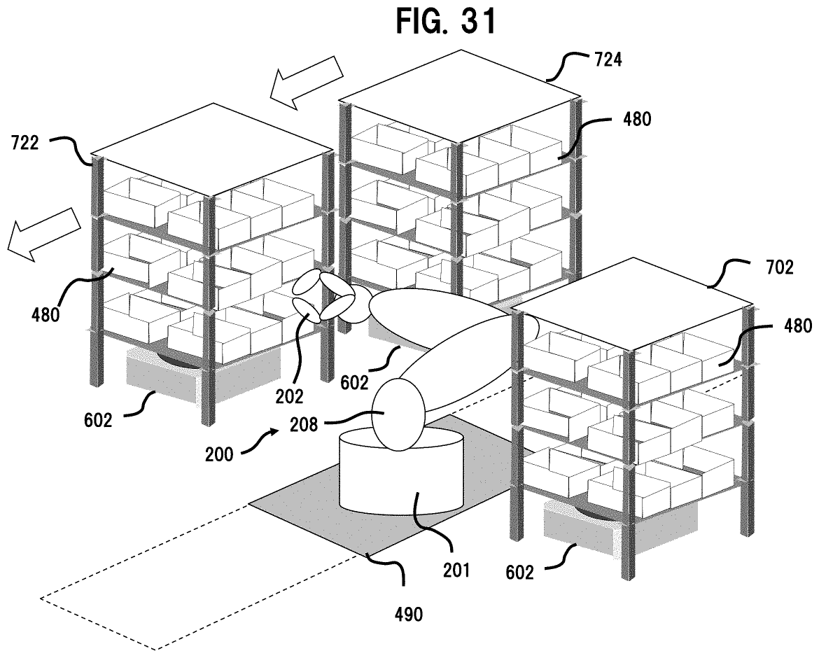

FIG. 30 is a flow chart of processing applied to the configuration shown in FIG. 29 by the central controller 800.

When the processing starts in Step S600 in FIG. 30, the processing proceeds to Step S601. Here, the central controller 800 searches for the object 203 to be unloaded based on object data on the objects stored in the warehouse 100, and identifies the storage shelf 702 that stores the target object and the position of the object 203 in the storage shelf. Next, when the processing proceeds to Step S602, the central controller 800 moves the identified storage shelf 702 to the unloading gate 330 using the transfer robot 602.

Next, when the processing proceeds to Step S603, under control of the central controller 800, the robot body 201 moves on the rails 492 to the position where the robot arm 208 and the robot hand 202 easily take out the target object 203. Next, when the processing proceeds to Step S604, under control of the central controller 800, the arm robot 200 draws the bucket 480 using the robot arm 208 and the robot hand 202 to take out the target object 203. Next, when the processing proceeds to Step S605, the central controller 800 moves the robot body 201 on the rails 492 such that the taken object is stored at a designated position in the sort shelf 902.

Next, when the processing proceeds to Step S606, under control of the central controller 800, the arm robot 200 stores the taken object at the designated position in the sort shelf 902.

In the example shown in FIG. 29, the arm robot 200 draws the bucket 480, but as shown in FIGS. 26 and 27, the stacker crane 482 may be provided and draw the bucket 480 storing the target object.

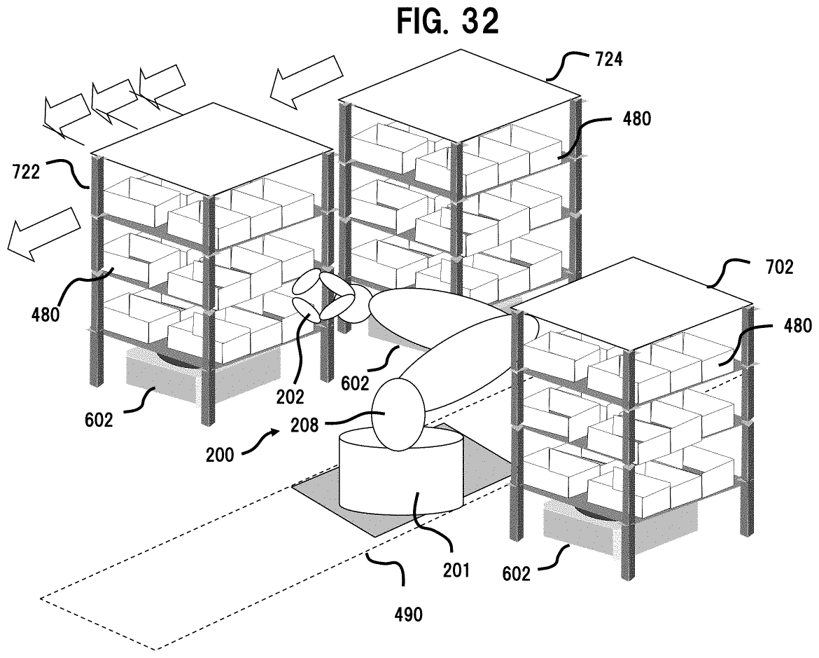

FIG. 31 is a schematic view showing a configuration in which the target object is taken out of the storage shelf 702 and sorted to the other storage shelves 722, 724 (sort shelves) at the unloading gate 330 (see FIG. 2).

In the example shown in FIG. 29, the robot body 201 moves on the two rails 492. In contrast, in the example shown in FIG. 31, in place of the sort shelf 902, the storage shelves 722, 724 are used. That is, as necessary, the transfer robot 602 moves the storage shelves 722, 724 to the operation range of the arm robot 200.

Thereby, the object 203 (see FIG. 3) taken from the bucket 480 in the storage shelf 702 may be moved to the buckets 480 in the storage shelves 722, 724 by operating the robot arm 208 and the robot hand 202 without moving the robot body 201 of the arm robot 200. That is, in the storage shelves 722, 724, an opened space of the bucket 480 placed as opposed to the arm robot 200 may store the object 203.

When no space is present in the bucket 480 on the surfaces of the storage shelves 722, 724 opposed to the arm robot 200, the transfer robot 602 rotates the storage shelves 722, 724 such that the bucket 480 on the opposite side may store the object. When no space is present in all the buckets 480 of storage shelves 722, 724, the transfer robot 602 moves another new storage shelf (not shown) to the operation range of the arm robot 200. Thus, the object may be stored in the new storage shelf in the same manner. As described above, in the example shown in FIG. 31, the storage shelves 722, 724 each function as the sort shelf.

FIG. 32 is a schematic view showing another configuration in which the target object is taken out of the storage shelf 702 and stored in the other storage shelves 722, 724 at the unloading gate 330 (see FIG. 2).

A difference between the example shown in FIG. 32 and the example shown in FIG. 31 is that the transfer robot 602 minutely drives the storage shelves 722, 724 each functioning as the sort shelf. That is, the transfer robot 602 minutely moves the storage shelves 722, 724 in unit of width of the bucket 480 according to the place of the bucket 480 that stores the target object.

In the example shown in FIG. 32, when the object to be picked is put into the storage shelves 722, 724, the central controller 800 determines which bucket 480 in the storage shelves 722, 724, the target object is to be stored. The transfer robot 602 laterally moves the storage shelves 722, 724 in the unit of width of the bucket 480 so as to coincide the position of the bucket 480 with the moving position of the robot hand 202. This may reduce the moving distance of the robot arm 208 and the robot hand 202 and makes it possible to rapidly perform the step of storing the object picked from the storage shelf 702 into the storage shelves 722, 724.

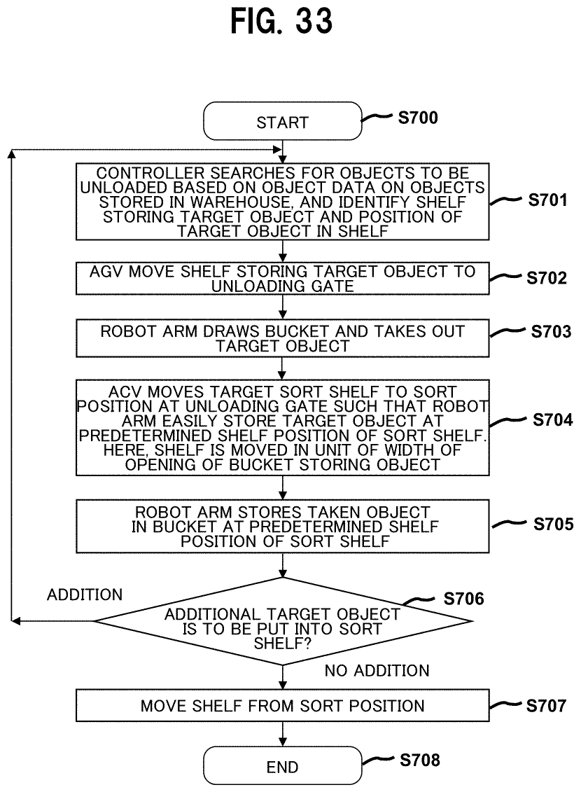

FIG. 33 is a flow chart of the processing applied to the configuration shown in FIGS. 31 and 32 by the central controller 800.

When the processing starts in Step S700 in FIG. 33, the processing proceeds to Step S701. Here, the central controller 800 searches for the object 203 to be unloaded based on object data on the objects stored in the warehouse 100, and identifies the storage shelf 702 that stores the target object and the position of the object 203 in the storage shelf. Next, when the processing proceeds to Step S702, the central controller 800 moves the identified storage shelf 702 to the unloading gate 330 using the transfer robot 602.

Next, when the processing proceeds to Step S703, under control of the central controller 800, the arm robot 200 draws the bucket 480 from the storage shelf 702 using the robot arm 208 and the robot hand 202 to take out the target object 203. Next, when the processing proceeds to Step S704, under control of the central controller 800, the transfer robot 602 moves the sort storage shelves 722, 724 to the sort position of the unloading gate 330. Describing in more detail, the transfer robot 602 moves the storage shelves 722, 724 in unit of width of the bucket 480 such that the robot arm 208 and the robot hand 202 may easily store the target object at the designated position in the sort storage shelves 722, 724.

Next, when the processing proceeds to Step S705, under control of the central controller 800, the arm robot 200 stores the object in the bucket 480 at the designated position of the sort storage shelves 722, 724. Next, when the processing proceeds to Step S706, the central controller 800 determines whether or not an additional target object is to be put into the sort storage shelves 722, 724. When the determination result is affirmative (addition), the processing returns to Step S701, the same processing as the above-mentioned processing is repeated. On the contrary, when the determination result is negative (no addition), the storage shelf 702 is moved from the sort position.

In the example described with reference to FIG. 31 to FIG. 33, the arm robot 200 draws the bucket 480, but as shown in FIGS. 26 and 27, the stacker crane 482 may be provided and draw the bucket 480 storing the target object. After the taken bucket 480 is moved to the buffer shelf 484 (see FIG. 27), the arm robot 200 may be take the object out of the bucket 480.

In Step S704, the sort storage shelves 722, 724 are moved in unit of width of the bucket using the transfer robot 602, but as shown in FIG. 31, the object may be stored in the storage shelves 722, 724, with the sort storage shelves 722, 724 fixed, by using the rapidly-operating arm robot 200.

As described above, the configuration shown in FIGS. 29 to 33 includes: the storage shelf (702) that stores the object to be unloaded (203); the sort shelf (902, 722, 724) that sorts the object (203) for each destination; the arm robot (200) that takes the object (203) out of the storage shelf (702) and stores the object at the designated place in the sort shelf (902, 722, 724); and the transfer device (201, 602) that moves the arm robot (200) or the sort shelf (722, 724) so as to reduce the distance between the arm robot (200) and the designated place.

Thereby, the step of storing the object (203) taken from the storage shelf (702) in the sort shelves (902, 722, 724) may be rapidly performed.

With the configuration shown in FIGS. 31 and 32, the transfer device (602) is the transfer robot (602) that enters below the sort shelf (722, 724) and pushes the sort shelf (722, 724) upwards to support and move the sort shelf (722, 724). The sort shelf (722, 724) and the transfer robot (602) are used in each zone (11, 12, 13), thereby standardizing various members in the warehouse (100).

### [Detection of Closeness of Obstacle]

Generally, when the transfer robot 602 is operated in the warehouse system, the operation area of the transfer robot 602 and the work area of the operator are set so as not overlap each other. This is due to that the operator and a cargo carried by the operator may become an obstacle in operating the transfer robot 602. However, the combination of the operator and the transfer robot 602 may achieve the efficient loading operation. To enable such operation, it is demanded to properly operate the transfer robot 602 with the obstacle.

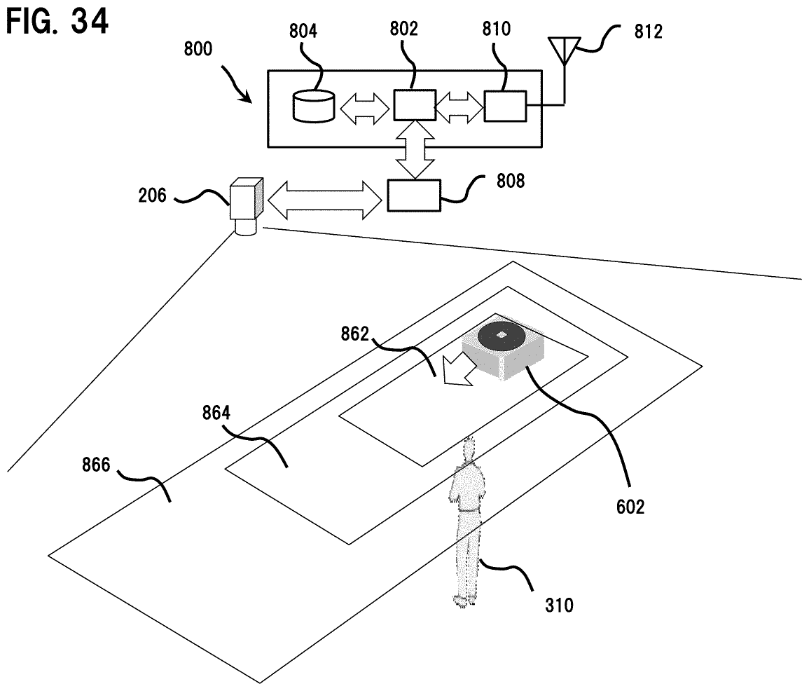

FIG. 34 is an explanatory view showing operations in the case where the transfer robot 602 detects an obstacle. FIG. 34 shows an example in which the operator 310 is the obstacle. In FIG. 34, unless otherwise specified, members having the same reference numerals as in FIGS. 1 to 33 have similar configurations and effects.

In the present embodiment, the sensor 206 such as a camera is arranged on a ceiling in the area where the transfer robot 602 operates, and monitors the transfer robot 602 and the surrounding state.

In the present embodiment, to avoid a collision with the obstacle (operator 310 and the like), following virtual areas 862, 864, and 866 are set ahead in the moving direction of the transfer robot 602.

(1) the area 866 in front of the transfer robot 602 by 5 m to 3 m

(2) the area 864 in front of the transfer robot 602 by 3 m to 1 m

(3) the area 862 in front of the transfer robot 602 by 1 m or less

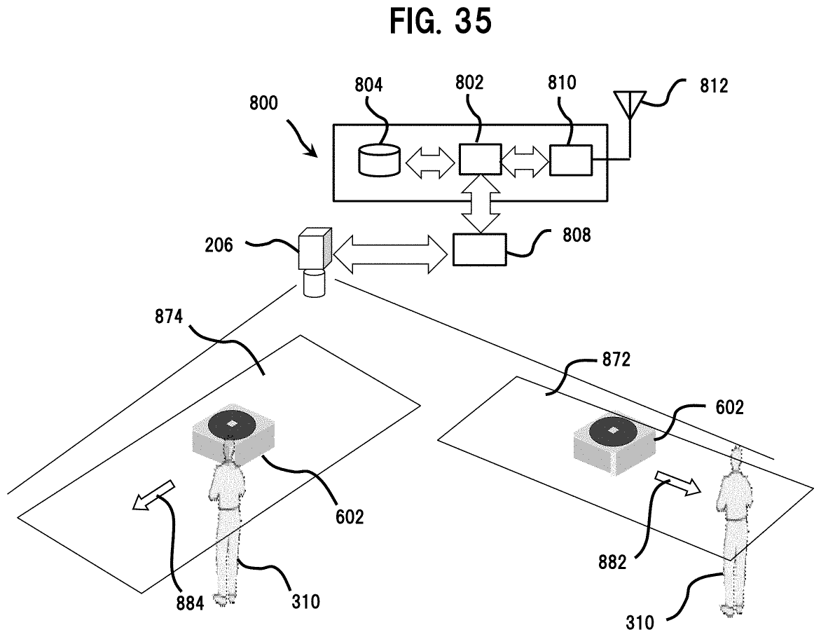

FIG. 35 is a schematic view showing the case where the plurality of transfer robots 602 move along different paths 882, 884.

In the example shown in FIG. 35, the two transfer robots 602 move along the different paths 882, 884. The paths 882, 884 are virtual paths on the floor surface, and are not physically formed on the floor surface.

The central controller 800 sets virtual areas 872, 874 for the transfer robots 602 to control the operation state of each transfer robot 602 to avoid a collision with an obstacle (operator 310 or the like).

In the example shown in FIG. 35, two transfer robots 602 are used, but the number of the transfer robots 602 may be three.

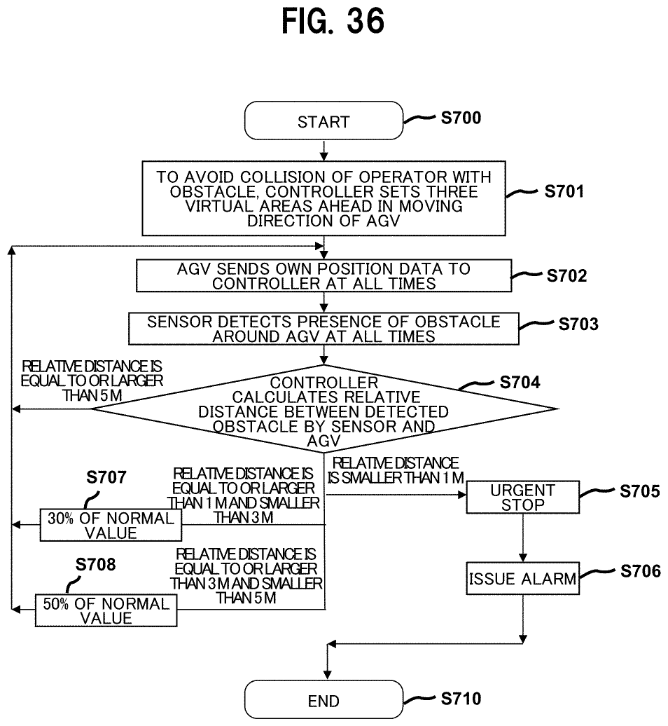

FIG. 36 is a flow chart of the processing executed to avoid a collision of the operator 310 or the like with the obstacle by the central controller 800.

When the processing starts in Step S700 in FIG. 36, the processing proceeds to Step S701. Here, to avoid the collision of the operator 310 or the like with the obstacle, the central controller 800 sets following three virtual areas with respect to the moving direction of the transfer robot 602.

(1) the area 866 in front of the transfer robot 602 by 5 m to 3 m

(2) the area 864 in front of the transfer robot 602 by 3 m to 1 m

(3) the area 862 in front of the transfer robot 602 by 1 m or less

Next, when the processing proceeds to Step S702, the transfer robot 602 sends own position data to the central controller 800. However, irrespective of the execution timing of Step S702, the transfer robot 602 sends own position data to the central controller 800 at all times. Next, when the processing proceeds to Step S703, the sensor 206 detects whether or not an obstacle is present around the transfer robot 602. However, irrespective of the execution timing of Step S703, the sensor 206 detects whether or not an obstacle is present around the transfer robot 602.

Next, when the processing proceeds to Step S704, the central controller 800 calculates a relative distance between the obstacle detected by the sensor 206 and the transfer robot 602, and branches the processing according to the calculation result. First, when the relative distance is equal to or smaller than 1 m, the processing proceeds to Step S705, and the central controller 800 urgently stops the transfer robot 602. Next, when the processing proceeds to Step S706, the central controller 800 issues an alarm to an information terminal (smart phone, smart watch, or the like) of the operator 310.

On the contrary, when the calculated relative distance is equal to or larger than 1 m and less than 3 m, the processing proceeds from Steps S704 to S707. In Step S707, the central controller 800 reduces the speed of the transfer robot 602 to 30% of normal speed. On the contrary, when the calculated relative distance is equal to or larger than 3 m and less than 5 m, the processing proceeds from Steps S704 to S708. In Step S708, the central controller 800 reduces the speed of the transfer robot 602 to 50% of the normal speed.

When Step S707 or S708 is executed, the processing returns to Step S702. When the calculated relative distance is 5 m or more, the processing returns to Step S702 without reducing the speed of the transfer robot 602. In this manner, unless urgent stop (Step S705) occurs, the same processing as the above-mentioned processing is repeated.

Through the above-mentioned processing, the transfer robot 602 may be safely operated while enabling movement of the operator 310. That is, the work area of the operator 310 and the work area of the transfer robot 602 may overlap each other, achieving an efficient loading operation.

As described above, the configuration shown in FIGS. 34 to 36 includes: the transfer robot (602) that travels in the warehouse (100); the sensor (206) that detects the obstacle (310) to the transfer robot (602) and the transfer robot (602); and the controller (800) that performs such a control as to reduce the speed of the transfer robot (602) as the transfer robot (602) comes closer to the obstacle (310) based on the detection result of the sensor (206).

When the distance between the transfer robot (602) and the obstacle (310) is a predetermined value or less, the controller (800) stops the transfer robot (602).

Thereby, even when the obstacle (310) such as the operator is present, the transfer robot (602) may be operated to achieve the efficient loading operation.

### [Modifications]

The present invention is not limited to the above-mentioned embodiment, and may be modified in various manners. The above-mentioned embodiment is shown for describing the present invention in an easily understandable manner, and is not limited to include all of the described constituents. Any other configuration may be added to the above-mentioned configuration, and a part of the configuration may be replaced with another configuration. Control lines and information lines in the figures are drawn for explanation, and do not necessarily indicate all required control lines and information lines. Actually, almost all constituents may be interconnected.

### REFERENCE SIGNS LIST

11, 12, 13 Zone
100 Warehouse
120, 122, 124, 126, 130 Transfer line
152 Floor surface
200, 200-1 to 200-n Arm robot
201 Robot body
202 Robot hand
203 Object
206 Sensor
207 Position sensor
208 Robot arm
229 Robot teaching database
230, 230A Second robot data generation unit (robot data generation unit)
264 Data generation unit (robot data generation unit)
300 Warehouse system
310 Operator (obstacle)
330 Unloading gate
410 Analysis processor
480 Bucket
482 Stacker crane
484 Buffer shelf
560 Container (transfer target)
602 Transfer robot
702, 704, 706, 708, 710, 712, 714, 732, 742 Storage shelf
716 Storage shelf (first storage shelf)
720 Storage shelf (second storage shelf)
722, 724 Storage shelf (sort shelf)
800 Central controller (controller)
852 Receiving base
852a Upper plate
854 Receiving object (inspection target)
860 Controller
902 Sort shelf
81′ to θn′ Robot teaching data
Q201 Robot body coordinates (robot body coordinates model value)
Q202 Robot hand coordinates (robot hand coordinates model value)
Q206 Sensor coordinates (sensor coordinates model value)
Q602 Transfer robot coordinates (transfer robot coordinates model value)
Q702 Storage shelf coordinates (storage shelf coordinates model value)
th1 Threshold (first threshold)
th2 Threshold (second threshold)

1. A warehouse system comprising:
a storage shelf configured to store an object;
an arm robot including a mono-articulated or multi-articulated robot arm, a robot body supporting the robot arm, and a robot hand that is attached to the robot arm and grasps the object, the arm robot being configured to take the object out of the storage shelf;
a transfer robot configured to transfer the storage shelf to an operation range of the arm robot;
a robot teaching database configured to store raw teaching data that are teaching data for the arm robot based on a storage shelf coordinates model value that is a three-dimensional coordinates model value of the storage shelf and a robot hand coordinates model value that is a three-dimensional coordinates model value of the robot hand; and
a robot data generation unit configured to correct the raw teaching data based on a detection result of a sensor detecting a relative position relationship between the storage shelf and the robot hand, and to generate robot teaching data to be supplied to the arm robot.

2.-8. (canceled)

9. The warehouse system according to claim 1, wherein
the raw teaching data is teaching data for the arm robot based on a sensor coordinates model value that is a three-dimensional coordinates model value of the sensor, a transfer robot coordinates model value that is a three-dimensional coordinates model value of the transfer robot, and a robot body coordinates model value that is a three-dimensional coordinates model value of the robot body, in addition to the storage shelf coordinates model value and the robot hand coordinates model value.

10.-17. (canceled)
